(19) United States
(12) Patent Application Publication
(10) Pub. No.: US 2023/0122460 A1
(43) Pub. Date: Apr. 20, 2023

(54) METHOD AND DEVICE FOR PERFORMING CELL RESELECTION PROCEDURE

(71) Applicant: Samsung Electronics Co., Ltd., Suwon-si (KR)

(72) Inventors: Sangyeob JUNG, Suwon-si (KR); Anil AGIWAL, Suwon-si (KR); Hyunjeong KANG, Suwon-si (KR)

(21) Appl. No.: 17/966,491

(22) Filed: Oct. 14, 2022

(30) Foreign Application Priority Data
Oct. 20, 2021 (KR) 10-2021-0140589

(51) Int. Cl. H04W 36/16; H04W 36/00; H04W 72/10

(52) U.S. Cl. CPC H04W 36/16; H04W 36/0016; H04W 72/10

(57) ABSTRACT

The method relates to a fifth generation (5G) or sixth generation (6G) communication system for supporting a higher data transmission rate. A method performed by a terminal in a wireless communication system is provided. The method includes receiving a radio resource control (RRC) release message including first information on cell reselection priority for slice, storing the first information on cell reselection priority for slice, starting a timer for cell reselection, in case that time value for the timer is included in the RRC release message, and performing cell reselection based on the first information on cell reselection priority for slice, in case that the timer does not expire.

### CROSS-REFERENCE TO RELATED APPLICATION(S)

This application is based on and claims priority under 35 U.S.C. § 119(a) of a Korean patent application number 10-2021-0140589, filed on Oct. 20, 2021, in the Korean Intellectual Property Office, the disclosure of which is incorporated by reference herein in its entirety.

### BACKGROUND

### 1. Field

The disclosure relates to a method and a device for performing a cell reselection procedure. More particularly, the disclosure relates to a method and a device wherein, in a next-generation mobile communication system, a terminal supporting a slice-based cell reselection procedure falls back to a cell reselection procedure which does not consider a slice.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI (from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device for performing a cell reselection procedure.

Another aspect of the disclosure is to provide a method and a device wherein, in a next-generation mobile communication system, a terminal supporting a slice-based cell reselection procedure falls back to a cell reselection procedure which does not consider a slice.

Additional aspects will be set forth in part in the description which follows and, in part, will be apparent from the description, or may be learned by practice of the presented embodiments.

Another aspect of the disclosure is to provide a method for processing a control signal in a wireless communication system, including receiving a first control signal transmitted from a base station, processing the received first control signal, and transmitting a second control signal generated based on the processing to the base station.

In accordance with an aspect of the disclosure a method performed by a terminal in a wireless communication system is provided. The method includes receiving a radio resource control (RRC) release message including first information on cell reselection priority for slice, storing the first information on cell reselection priority for slice, starting a timer for cell reselection, in case that time value for the timer is included in the RRC release message, and performing cell reselection based on the first information on cell reselection priority for slice, in case that the timer does not expire.

In accordance with another aspect of the disclosure, a method performed by a base station in a wireless communication system is provided. The method includes transmitting, to a terminal, an RRC release message including first information on cell reselection priority for slice and second information on cell reselection priority, and performing cell reselection with the terminal based on the first information on cell reselection priority for slice, in case that a timer does not expire, wherein time value for the timer is included in the RRC release message, and wherein the time value for the timer is applied both the first information on cell reselection priority for slice and the second information on cell reselection priority.

In accordance with another aspect of the disclosure, a terminal in a wireless communication system is provided. The terminal includes a transceiver, and at least one processor configured to receive an RRC release message including first information on cell reselection priority for slice, store the first information on cell reselection priority for slice, start a timer for cell reselection, in case that time value for the timer is included in the RRC release message, and perform cell reselection based on the first information on cell reselection priority for slice, in case that the timer does not expire.

In accordance with another aspect of the disclosure, a base station in a wireless communication system is provided. The base station includes a transceiver, and at least one processor configured to transmit, to a terminal, an RRC release message including first information on cell reselection priority for slice and second information on cell reselection priority, and perform cell reselection with the terminal based on the first information on cell reselection priority for slice, in case that a timer does not expire, wherein time value for the timer is included in the RRC release message, and wherein the time value for the timer is applied both the first information on cell reselection priority for slice and the second information on cell reselection priority.

Another aspect of the disclosure is to provide a method and a device for performing a cell reselection procedure.

In addition, various embodiments of the disclosure, provide a method and a device wherein, in a next-generation mobile communication system, a terminal supporting a slice-based cell reselection procedure falls back to a cell reselection procedure which does not consider a slice.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long-term evolution (LTE) system according to an embodiment of the disclosure;

FIG. 2 illustrates a wireless protocol structure in an LTE system according to an embodiment of the disclosure;

FIG. 3 illustrates a structure of a next-generation mobile communication system according to an embodiment of the disclosure;

FIG. 4 illustrates a wireless protocol structure of a next-generation mobile communication system according to an embodiment of the disclosure;

FIG. 5 illustrates that a terminal in an RRC idle mode (RRC_IDLE) or an RRC inactive state (RRC_INACTIVE) in a next-generation mobile communication system performs a cell reselection evaluation procedure, based on a reselection priority broadcasted via system information, without considering a slice according to an embodiment of the disclosure;

FIG. 6 illustrates that a terminal in an RRC idle mode (RRC_IDLE) or an RRC inactive state (RRC_INACTIVE) in a next-generation mobile communication system performs a cell reselection evaluation procedure, based on a reselection priority provided by an RRC release message, without considering a slice according to an embodiment of the disclosure;

FIG. 7 illustrates that a terminal in an RRC idle mode (RRC_IDLE) or an RRC inactive state (RRC_INACTIVE) in a next-generation mobile communication system applies slice-based cell reselection priority (slice-based reselection priorities) information broadcasted via system information to fall back to a cell reselection evaluation procedure without consideration of a slice in a slice-based cell reselection evaluation procedure, and to reselect a cell according to an embodiment of the disclosure;

FIG. 8 illustrates that a terminal in an RRC idle mode (RRC_IDLE) or an RRC inactive state (RRC_INACTIVE) in a next-generation mobile communication system applies slice-based cell reselection priority (slice-based reselection priorities) information provided by an RRC release message to perform a slice-based cell reselection evaluation procedure according to an embodiment of the disclosure;

FIG. 9 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure;

FIG. 10 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure;

FIG. 11 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure;

FIG. 12 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure;

FIG. 13 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure;

FIG. 14 is a block diagram illustrating a configuration of a terminal according to an embodiment of the disclosure; and

FIG. 15 is a block diagram illustrating a configuration of an NR base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing communication functions. Further, embodiments of the disclosure as described below may be applied to other communication system a having similar technical backgrounds or channel types to the embodiments of the disclosure. Moreover, based on determinations by those skilled in the art, the embodiments of the disclosure may also be applied to other communication systems through some modifications without significantly departing from the scope of the disclosure. Examples of such communication systems may include 5th generation mobile communication technologies (5G, new radio, and NR) developed beyond long term evolution advanced (LTE-A), and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, terms and names defined in the 3rd generation partnership project long term evolution (3GPP LTE) standards and/or 3GPP new radio (3GPP NR) standards may be used for the convenience of description. However, the disclosure is not limited by these terms and names, and may be applied in the same way to systems that conform other standards.

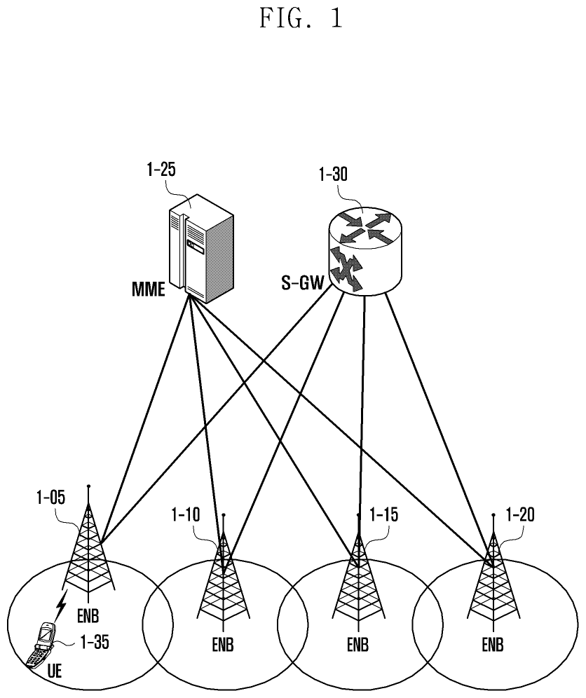

FIG. 1 illustrates a structure of an LTE system according to an embodiment of the disclosure.

Referring to FIG. 1, a radio access network of an LTE system includes a next-generation base station (evolved a node B, hereinafter, referred to as an ENB, a Node B, or a base station) 1-05, 1-10, 1-15, or 1-20, a mobility management entity (MME) 1-25, and a serving-gateway (S-GW) 1-30. A user equipment (hereinafter, referred to as a UE or a terminal) 1-35 accesses an external network via the ENB 1-05, 1-10, 1-15, or 1-20 and the S-GW 1-30.

Referring to FIG. 1, the ENBs 1-05, 1-10, 1-15, and 1-20 correspond to the existing Node B of a universal mobile telecommunications system (UMTS) system. The ENB 1-05 is connected to the UE 1-35 via a wireless channel and performs a more complex role than the existing Node B. In the LTE system, since all user traffics including a real-time service, such as voice over IP (VoIP), through the Internet protocol, are serviced via a shared channel, a device for collecting and scheduling state information, such as a buffer state, an available transmission power state, and a channel state of UEs is required, and the ENBs 1-05, 1-10, 1-15, and 1-20 serve as such a device. In general, one ENB controls multiple cells. For example, in order to implement a transmission rate of 100 Mbps, the LTE system uses, as a radio access technology (RAT), orthogonal frequency division multiplexing (OFDM) in, for example, a bandwidth of 20 MHz. In addition, an adaptive modulation and coding (hereinafter, referred to as AMC) scheme for determining a modulation scheme and a channel coding rate according to a channel state of a terminal is applied. The S-GW 1-30 is a device configured to provide a data bearer, and generates or removes a data bearer under the control of the MME 1-25. The MME 1-25 is a device responsible for various control functions as well as a mobility management function for the terminal 1-35, and is connected to the plurality of base stations 1-05, 1-10, 1-15, and 1-20.

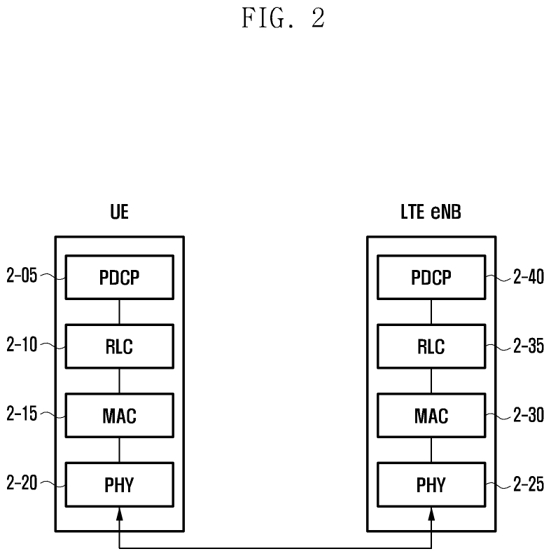

FIG. 2 illustrates a wireless protocol structure in an LTE system according to an embodiment of the disclosure.

Referring to FIG. 2, in a wireless protocol of an LTE system, a terminal and an ENB include packet data convergence protocols (PDCPs) 2-05 and 2-40, radio link controls (RLCs) 2-10 and 2-35, and medium access controls (MACs) 2-15 and 2-30, respectively. The packet data convergence protocols (PDCPs) 2-05 and 2-40 are in charge of IP header compression/restore operations. The main functions of the PDCP are summarized as follows.
Header compression and decompression function (Header compression and decompression: robust header compression (ROHC) only)
User data transmission function (Transfer of user data)
In-sequence delivery function (In-sequence delivery of upper layer protocol data units (PDUs) at PDCP re-establishment procedure for RLC AM)
Sequence reordering function (For split bearers in DC (only support for RLC AM): PDCP PDU routing for transmission and PDCP PDU reordering for reception)
Duplicate detection function (Duplicate detection of lower layer SDUs at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer-based SDU discard function (Timer-based SDU discard in uplink.)

The radio link controls (hereinafter, referred to as RLCs) 2-10 and 2-35 reconfigure a PDCP protocol data unit (PDCP PDU) in an appropriate size to perform an ARQ operation or the like. The main functions of the RLC are summarized as follows.
Data transmission function (Transfer of upper layer PDUs)
ARQ function (Error Correction through ARQ (only for AM data transfer))
Concatenation, segmentation, and reassembly functions (Concatenation, segmentation and reassembly of RLC SDUs (only for UM and AM data transfer))
Re-segmentation function (Re-segmentation of RLC data PDUs (only for AM data transfer))
Reordering function (Reordering of RLC data PDUs (only for UM and AM data transfer))
Duplicate detection function (Duplicate detection (only for UM and AM data transfer))
Error detection function (Protocol error detection (only for AM data transfer))
RLC SDU discard function (RLC SDU discard (only for UM and AM data transfer))
RLC re-establishment function (RLC re-establishment)

The MACs 2-15 and 2-30 are connected to several RLC layer devices configured in one device and perform an operation of multiplexing RLC PDUs into an MAC PDU and demultiplexing the RLC PDUs from the MAC PDU. The main functions of the MAC are summarized as follows.
Mapping function (Mapping between logical channels and transport channels)
Multiplexing and demultiplexing function (Multiplexing/demultiplexing of MAC SDUs belonging to one or different logical channels into/from transport blocks (TB) delivered to/from the physical layer on transport channels)
Scheduling information reporting function (Scheduling information reporting)
HARQ function (Error correction through HARQ)
Priority handling function between logical channels (Priority handling between logical channels of one UE)
Priority handling function between terminals (Priority handling between UEs by means of dynamic scheduling)
MBMS service identification function (MBMS service identification)
Transmission format selection function (Transport format selection)
Padding function (Padding)

Physical layers 2-20 and 2-25 perform an operation of channel-coding and modulating upper layer data into OFDM symbols to transmit the OFDM symbols via a wireless channel, or an operation of demodulating and channel-decoding OFDM symbols received via a wireless channel to deliver the demodulated and channel-decoded OFDM symbols to an upper layer.

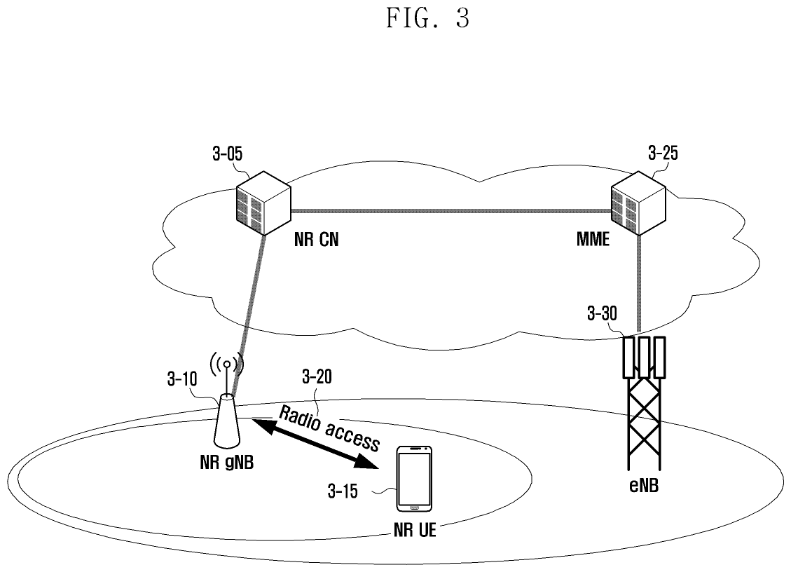

FIG. 3 illustrates a structure of a next-generation mobile communication system according to an embodiment of the disclosure.

Referring to FIG. 3, a radio access network of a next-generation mobile communication system (hereinafter, referred to as NR or 2g) includes a next-generation base station (new radio node B, hereinafter, referred to as an NR gNB or an NR base station) 3-10 and a new radio core network (NR CN) 3-05. A user equipment (new radio user equipment hereinafter, referred to as an NR UE or a terminal) 3-15 accesses an external network via the NR gNB 3-10 and the NR CN 3-05.

Referring to FIG. 3, the NR gNB 3-10 corresponds to an evolved node B (eNB) of the existing LTE system. The NR gNB 3-10 is connected to the NR UE 3-15 via a wireless channel and can provide a service superior to that of the existing node B. In the next-generation mobile communication system, since all user traffics are serviced via a shared channel, a device for collecting and scheduling state information, such as a buffer state, an available transmission power state, and a channel state of UEs is required, and the NR gNB 3-10 serves as such a device. In general, one NR gNB controls multiple cells. In order to realize ultra-high-speed data transmission compared to the existing LTE system, the next-generation mobile communication system may have a bandwidth equal to or greater than the maximum bandwidth of the existing system, may use, as a radio access technology, an orthogonal frequency division multiplexing (hereinafter, referred to as OFDM) scheme, and may additionally employ a beamforming technique in addition thereto. In addition, an adaptive modulation and coding (hereinafter, referred to as AMC) scheme for determining a modulation scheme and a channel coding rate according to a channel state of a terminal is applied. The NR CN 3-05 performs functions, such as mobility support, bearer configuration, and quality of service (QoS) configuration. The NR CN 3-05 is a device responsible for various control functions as well as a mobility management function for the terminal 3-15, and is connected to multiple base stations. In addition, the next-generation mobile communication system may interwork with the existing LTE system, and the NR CN 3-05 is connected to an MME 3-25 via a network interface. The MME 3-25 is connected to an eNB 3-30 which is the existing base station.

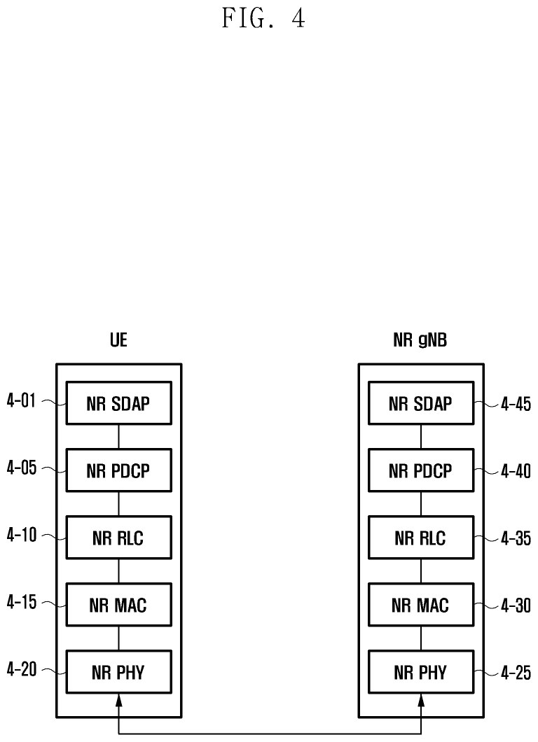

FIG. 4 illustrates a wireless protocol structure of a next-generation mobile communication system according to an embodiment of the disclosure.

Referring to FIG. 4, in a wireless protocol of a next-generation mobile communication system, a terminal and an NR base station include NR SDAPs 4-01 and 4-45, NR PDCPs 4-05 and 4-40, NR RLCs 4-10 and 4-35, and NR MACs 4-15 and 4-30, respectively.

The main functions of the NR SDAPs 4-01 and 4-45 may include some of the following functions.

User data transfer function (transfer of user plane data)

Mapping function of QoS flow and data bearer for uplink and downlink (mapping between a QoS flow and a data radio bearer (DRB) for both downlink (DL) and uplink (UL))

Marking function of QoS flow identifier (ID) for uplink and downlink (marking QoS flow ID in both DL and UL packets)

Function of mapping reflective QoS flow to data bearer for uplink SDAP PDUs (reflective QoS flow to DRB mapping for the UL SDAP PDUs)

With respect to an SDAP layer device, whether to use a header of the SDAP layer device or whether to use a function of the SDAP layer device may be configured for a terminal by an RRC message for each PDCP layer device, each bearer, or each logical channel. When an SDAP header is configured, an NAS QoS reflection configuration 1-bit indicator (NAS reflective QoS) and an AS QoS reflection configuration 1-bit indicator (AS reflective QoS) of the SDAP header may provide indication to a terminal such that the terminal may update or reconfigure mapping information on a data bearer and a QoS flow of an uplink and a downlink. The SDAP header may include QoS flow ID information indicating QoS. The QoS information may be used as data processing priority, scheduling information, or the like to support a seamless service.

The main functions of the NR PDCPs 4-05 and 4-40 may include some of the following functions.
Header compression and decompression function (Header compression and decompression: ROHC only)
User data transmission function (Transfer of user data)
In-sequence delivery function (In-sequence delivery of upper layer PDUs)
Out-of-sequence delivery function (Out-of-sequence delivery of upper layer PDUs)
Sequence reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU discard function (Timer-based SDU discard in uplink.)

In the above description, the sequence reordering function (reordering) of an NR PDCP device refers to a function of sequentially reordering PDCP PDUs, received from a lower layer, based on a PDCP sequence number (SN), and may include a function of delivering data to an upper layer in a reordered sequence, or a function of immediately delivering data without considering the sequence, a function of recording lost PDCP PDUs by reordering the sequence, a function of reporting a state of the lost PDCP PDUs to a transmission side, and a function of requesting retransmission of the lost PDCP PDUs.

The main functions of the NR RLCs 4-10 and 4-35 may include some of the following functions.
Data transmission function (Transfer of upper layer PDUs)
In-sequence delivery function (In-sequence delivery of upper layer PDUs)
Out-of-sequence delivery function (Out-of-sequence delivery of upper layer PDUs)
ARQ function (Error Correction through ARQ)
Concatenation, segmentation, and reassembly functions (Concatenation, segmentation and reassembly of RLC SDUs)
Re-segmentation function (Re-segmentation of RLC data PDUs)
Sequence reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

In the above description, the in-sequence delivery function of an NR RLC device refers to a function of sequentially delivering RLC SDUs received from a lower layer to an upper layer, and may include a function of, when an original one RLC SDU is divided into multiple RLC SDUs and received, reassembling and delivering the multiple RLC SDUs, a function of reordering the received RLC PDUs based on an RLC sequence number (SN) or a PDCP sequence number (SN), a function of recording lost RLC PDUs by the reordering the sequence, a function of reporting a state of the lost RLC PDUs to a transmission side, a function of requesting retransmission of the lost RLC PDUs, a function of, when there is a lost RLC SDU, sequentially delivering only the RLC SDUs before the lost RLC SDU to the upper layer, a function of, if a predetermined timer expires even though there is a lost RLC SDU, sequentially delivering all RLC SDUs received before the timer starts to the upper layer, or a function of, if a predetermined timer expires even when there is a lost RLC SDU, sequentially delivering all RLC SDUs received up to that point in time to the upper layer. In addition, RLC PDUs may be processed in the order in which they are received (in the order of arrival, regardless of the order of serial number and sequence number), and delivered to the PDCP device regardless of the order (out-of-sequence delivery), and in the case of a segment, segments stored in a buffer or segments to be received later may be received, reconstructed into one complete RLC PDU, processed, and delivered to the PDCP device. The NR RLC layer may not include a concatenation function, and the function may be performed in an NR MAC layer or may be replaced with a multiplexing function of the NR MAC layer.

In the above description, the out-of-sequence delivery function (out-of-sequence delivery) of the NR RLC device refers to a function of directly delivering RLC SDUs received from a lower layer to an upper layer regardless of the order, and may include a function of, when an original one RLC SDU is divided into multiple RLC SDUs and received, reassembling and delivering the multiple RLC SDUs, and a function of storing RLC SNs or PDCP SNs of the received RLC PDUs, sorting the order, and recording lost RLC PDUs.

The NR MACs 4-15 and 4-30 may be connected to several NR RLC layer devices configured in one device, and the main functions of the NR MAC may include some of the following functions.
Mapping function (Mapping between logical channels and transport channels)
Multiplexing and demultiplexing function (Multiplexing/demultiplexing of MAC SDUs)
Scheduling information reporting function (Scheduling information reporting)
HARQ function (Error correction through HARQ)
Priority handling function between logical channels (Priority handling between logical channels of one UE)
Priority handling function between terminals (Priority handling between UEs by means of dynamic scheduling)
MBMS service identification function (MBMS service identification)
Transmission format selection function (Transport format selection)
Padding function (Padding)

NR PHY layers 4-20 and 4-25 may perform an operation of channel-coding and modulating upper layer data into OFDM symbols to transmit the OFDM symbols via a wireless channel, or an operation of demodulating and channel-decoding OFDM symbols received via a wireless channel to deliver the demodulated and channel-decoded OFDM symbols to an upper layer.

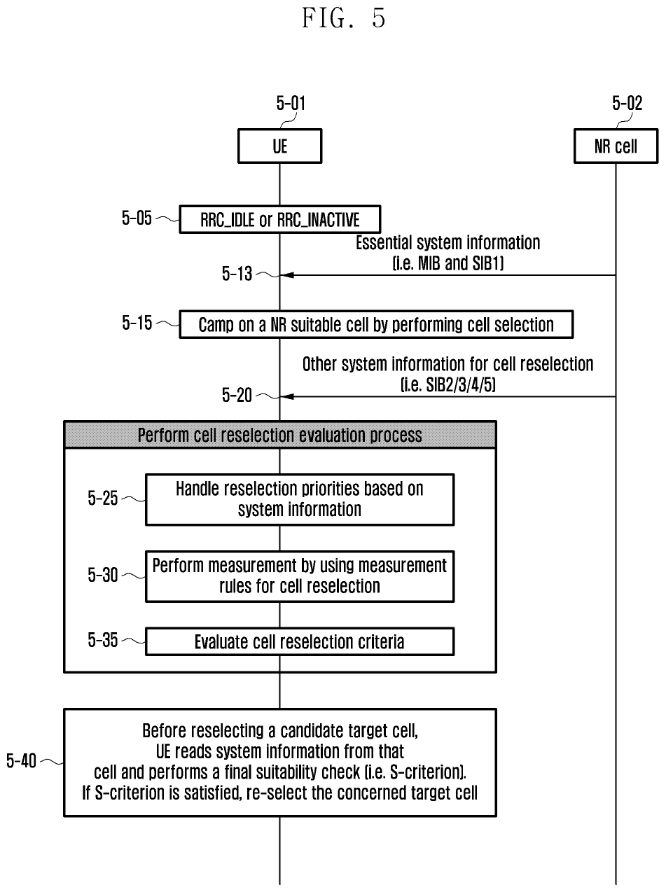

FIG. 5 illustrates that a terminal in an RRC idle mode (RRC_IDLE) or an RRC inactive state (RRC_INACTIVE) in a next-generation mobile communication system performs a cell reselection evaluation procedure, based on a reselection priority broadcasted via system information, without considering a slice according to an embodiment of the disclosure.

The cell reselection evaluation procedure may refer to a procedure in which when the service quality of a serving cell which a terminal in an RRC idle mode (RRC_IDLE) or an RRC inactive state (RRC_INACTIVE) is currently camping on becomes lower than the service quality of a neighboring cell (neighbour cell) due to a predetermined reason or movement, the terminal determines whether to maintain the current serving cell or reselect a cell as the neighboring cell.

While in the case of handover, whether to operate handover is determined by a network (an access and mobility management function (AMF) or source gNB), in the case of cell reselection, the terminal in the RRC idle mode or the RRC inactive state may determine whether to operate the cell reselection by itself, based on a cell measurement value. A cell to be reselected by the terminal may refer to a cell using the same NR frequency (NR intra-frequency or serving NR frequency) as the serving cell on which the terminal is currently camping, a cell using an NR frequency (NR inter-frequency) different from that of the serving cell, or a cell in a frequency (an inter-RAT frequency) using another radio access technology (radio access technology, hereinafter referred to as RAT).

According to an embodiment of the disclosure, in the serving cell on which the terminal is currently camping, a cell reselection priority value mapped to an NR frequency to which the serving cell belongs is always broadcasted via system information Therefore, when the terminal in the RRC idle mode or the RRC inactive state determines a cell reselection priority (reselection priorities handling), based on the system information, with reference to the cell reselection priority value mapped to the NR frequency to which the serving cell belongs, the terminal may determine whether a cell reselection priority for each NR inter-frequency or inter-RAT frequency has the same cell reselection priority as the NR frequency to which the serving cell belongs, whether the cell reselection priority has a higher cell reselection priority than the NR frequency to which the serving cell belongs, or whether the cell reselection priority has a lower cell reselection priority than the NR frequency to which the serving cell belongs. In addition, the terminal may perform frequency measurement by applying measurement rules for cell re-selection, based on a cell reselection priority determined for each frequency, and reselect a neighboring cell which satisfies cell reselection criteria.

Referring to FIG. 5, a terminal 5-01 may be in an RRC idle mode (RRC_IDLE) or an RRC inactive state (RRC_INACTIVE) (operation 5-05).

In operation 5-13, the terminal 5-01 in the RRC idle mode or the RRC inactive state may acquire essential system information from an NR cell 5-02. In an embodiment of the disclosure, a master information block (MIB) and system information block 1 (SIB1) may be referred to as essential system information.

In operation 5-15, the terminal 5-01 in the RRC idle mode or the RRC inactive state may perform a cell selection procedure, based on the essential system information acquired in operation 5-13. For example, the terminal 5-01 may find an NR suitable cell belonging to a selected public land mobile network (PLMN) or stand-alone non-public network (SNPN) and camp on the corresponding cell. The cell on which the terminal 5-01 has camped may be referred to as a serving cell. In an embodiment of the disclosure, when the conditions in Table 1 below are fulfilled based on the 3GPP standard document “38.304: User Equipment (UE) procedures in Idle mode and RRC Inactive state”, the cell may be defined as a suitable cell.

TABLE 1
suitable cell:

For UE not operating in SNPN Access Mode, a cell is considered as suitable if the
following conditions are fulfilled:
The cell is part of either the selected PLMN or the registered PLMN or PLMN of the
Equivalent PLMN list, and for that PLMN either:
The PLMN-ID of that PLMN is broadcast by the cell with no associated CAG-IDs and
CAG-only indication in the UE for that PLMN (TS 23.501 [10]) is absent or false;
Allowed CAG list in the UE for that PLMN (TS 23.501 [10]) includes a CAG-ID
broadcast by the cell for that PLMN;
The cell selection criteria are fulfilled, see clause 5.2.3.2.
According to the latest information provided by NAS:
The cell is not barred, see clause 5.3.1;
The cell is part of at least one TA that is not part of the list of “Forbidden Tracking
Areas for Roaming” (TS 22.011 [18]), which belongs to a PLMN that fulfils the first
bullet above.
For UE operating in SNPN Access Mode, a cell is considered as suitable if the following
conditions are fulfilled:
The cell is part of either the selected SNPN or the registered SNPN of the UE;
The cell selection criteria are fulfilled, see clause 5.2.3.2;
According to the latest information provided by NAS:
The cell is not barred, see clause 5.3.1;
The cell is part of at least one TA that is not part of the list of “Forbidden Tracking
Areas for Roaming” which belongs to either the selected SNPN or the registered SNPN
of the UE.

For reference, when Equation 1 below is satisfied, the terminal 5-01 may determine that cell selection criteria are fulfilled.

Srxlev>0 AND Squal>0

where

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ,

Squal=Q_{qualmeas}−(Q_{qualmin}+Q_{qualminoffset})−Qoffsetₜₑₘₚ Equation 1

The definition of parameters used therein refers to the 3GPP standard document “38.304: User Equipment (UE) procedures in Idle mode and RRC Inactive state”.

In operation 5-20, the terminal 5-01 in the RRC idle mode or the RRC inactive state may acquire system information (for example, SIB2, SIB3, SIB4, and SIB5) including cell reselection information from the serving cell (NR cell) 5-02 in order to perform a cell reselection evaluation procedure. The SIB2 may include information/parameters commonly applied to reselect NR intra-frequency, NR inter-frequency, and inter-RAT frequency cells by the terminal 5-01 and NR intra-frequency cell reselection information excluding information related to an NR intra-frequency neighboring cell. For example, the SIB2 may include one cell reselection priority configuration information for a serving NR frequency (a frequency to which the cell on which the terminal is currently camping belongs). The cell reselection priority configuration information may mean cellReselectionPriority and cellReselectionSubPriority. Specifically, the cellReselectionPriority may receive an integer value (for example, one integer value from 0 to 7), and the cellReselectionSubPriority may receive a decimal value (for example, one decimal value among 0.2, 0.4, 0.6, and 0.8). When both the cellReselectionPriority and cellReselectionSubPriority are signaled, the terminal 5-01 may derive a cell reselection priority value by adding the two values. For reference, a larger cell reselection priority value means a higher priority. In the serving cell 5-02 according to the disclosure, cellReselectionPriority mapped to the serving NR frequency is always (mandatory) broadcasted via the SIB2, and since cellReselectionSubPriority is optionally broadcasted, the cell reselection priority configuration information for the serving NR frequency is always broadcasted. Specifically, cell reselection configuration information broadcasted via the SIB2 may be as shown in Table 2 below.

TABLE 2

| | |
|---|---|
| SIB2 ::= | SEQUENCE { |
| cellReselectionInfoCommon | SEQUENCE { |
| nrofSS-BlocksToAverage | INTEGER (2..maxNrofSS-BlocksToAverage) |

| | |
|---|---|
| OPTIONAL, | -- Need S |

absThreshSS-BlocksConsolidation ThresholdNR

| | |
|---|---|
| OPTIONAL, | -- Need S |

| | | |
|---|---|---|
| rangeToBestCell | RangeToBestCell | OPTIONAL, - |

- Need R

| | |
|---|---|
| q-Hyst | ENUMERATED { |
| | dB0, dB1, dB2, dB3, dB4, dB5, dB6, dB8, dB10, |
| | dB12, dB14, dB16, dB18, dB20, dB22, dB24}, |
| speedStateReselectionPars | SEQUENCE { |
| mobilityStateParameters | , |
| q-HystSF | SEQUENCE { |
| sf-Medium | ENUMERATED {dB−6, dB−4, dB−2, dB0}, |
| sf-High | ENUMERATED {dB−6, dB−4, dB−2, dB0} |

}

| | |
|---|---|
| } | OPTIONAL, -- Need R |

```
  ...
  },
  cellReselectionServingFreqInfo SEQUENCE {
```

| | | |
|---|---|---|
| s-NonIntraSearchP | ReselectionThreshold | OPTIONAL, |

-- Need S

| | | |
|---|---|---|
| s-NonIntraSearchQ | ReselectionThresholdQ | OPTIONAL, |

-- Need S

| threshServingLowP | ReselectionThreshold, | |
|---|---|---|
| threshServingLowQ | ReselectionThresholdQ | OPTIONAL, |

-- Need R
cellReselectionPriority ,

| | | |
|---|---|---|
| cellReselectionSubPriority | OPTIONAL, | -- Need R |

```
    ...
  },
  intraFreqCellReselectionInfo SEQUENCE {
```

| q-RxLevMin | , | |
|---|---|---|
| q-RxLevMinSUL | Q-RxLevMin | OPTIONAL, |

-- Need R

| | |
|---|---|
| q-QualMin | OPTIONAL, -- Need S |

| s-IntraSearchP | ReselectionThreshold, | |
|---|---|---|
| s-IntraSearchQ | ReselectionThresholdQ | OPTIONAL, |

-- Need S

| | |
|---|---|
| t-ReselectionNR | T-Reselection, |
| frequencyBandList | MultiFrequencyBandListNR-SIB |

| | |
|---|---|
| OPTIONAL, | -- Need S |

| | |
|---|---|
| frequencyBandListSUL | MultiFrequencyBandListNR-SIB |

| | |
|---|---|
| OPTIONAL, | -- Need R |

| | |
|---|---|
| p-Max | OPTIONAL, -- Need S |

| | | |
|---|---|---|
| smtc | SSB-MTC | OPTIONAL, -Need |

S

| | |
|---|---|
| ss-RSSI-Measurement | OPTIONAL, -- Need R |
| ssb-ToMeasure | OPTIONAL, -- Need S |

| | |
|---|---|
| deriveSSB-IndexFromCell | BOOLEAN, |

```
    ...,
    [[
```

| | | |
|---|---|---|
| t-ReselectionNR-SF | SpeedStateScaleFactors | OPTIONAL |

```
-- Need N
    ]],
    [[
```

| | | |
|---|---|---|
| smtc2-LP-r16 | SSB-MTC2-LP-r16 | OPTIONAL, |

-- Need R
ssb-PositionQCL-Common-r16 SSB-PositionQCL-Relation-r16

| | |
|---|---|
| OPTIONAL | -- Cond SharedSpectrum |

```
    ]]
  },
  ...,
  [[
```

| | |
|---|---|
| relaxedMeasurement-r16 | SEQUENCE { |
| lowMobilityEvaluation-r16 | SEQUENCE { |
| s-SearchDeltaP-r16 | ENUMERATED { |
| | dB3, dB6, dB9, dB12, dB15, |
| | spare3, spare2, spare1}, |
| t-SearchDeltaP-r16 | ENUMERATED { |
| | s5, s10, s20, s30, s60, s120, s180, |
| | s240, s300, spare7, spare6, spare5, |
| | spare4, spare3, spare2, spare1} |

| | |
|---|---|
| } | OPTIONAL, -- Need R |

| cellEdgeEvaluation-r16 | SEQUENCE { | |
|---|---|---|
| s-SearchThresholdP-r16 | ReselectionThreshold, | |
| s-SearchThresholdQ-r16 | ReselectionThresholdQ | OPTIONAL |

-- Need R

| | |
|---|---|
| } | OPTIONAL, -- Need R |

combineRelaxedMeasCondition-r16 ENUMERATED {true}

| | |
|---|---|
| OPTIONAL, | -- Need R |

| | |
|---|---|
| highPriorityMeasRelax-r16 | ENUMERATED {true } |

| | |
|---|---|
| OPTIONAL | -- Need R |

| | |
|---|---|
| } | OPTIONAL -- Need R |

]]
}
RangeToBestCell ::= Q-OffsetRange

The SIB3 may include neighboring cell information/parameters for reselecting an NR intra-frequency cell by the terminal 5-01 in the RRC idle mode or the RRC inactive state. For example, via the SIB3, an NR intra-frequency cell list (intraFreqNeighCellList) for reselecting an NR intra-frequency cell or a cell list (intraFreqBlackCellList) in which NR intra-frequency cell reselection is not allowed may be broadcasted. Specifically, information in Table 3 below may be broadcasted via the SIB3.

TABLE 3

| | |
|---|---|
| SIB3 ::= | SEQUENCE { |

| | |
|---|---|
| intraFreqNeighCellList | OPTIONAL, -- Need R |
| intraFreqBlackCellList | OPTIONAL, -- Need R |

| | |
|---|---|
| lateNonCriticalExtension | OCTET STRING |

OPTIONAL,
...,
[[

| | |
|---|---|
| intraFreqNeighCellList-v1610 | OPTIONAL, -- Need R |
| intraFreqWhiteCellList-r16 | OPTIONAL, -- Cond |

SharedSpectrum2

| | |
|---|---|
| intraFreqCAG-CellList-r16 | SEQUENCE (SIZE (1..maxPLMN)) OF |

IntraFreqCAG-CellListPerPLMN-r16 OPTIONAL -- Need R
]]
}

| | |
|---|---|
| IntraFreqNeighCellList ::= | SEQUENCE (SIZE (1..maxCelllntra)) OF |

IntraFreqNeighCelllnfo

| | |
|---|---|
| IntraFreqNeighCellList-v1610::= | SEQUENCE (SIZE (1..maxCelllntra)) OF |

IntraFreqNeighCellInfo-v1610

| IntraFreqNeighCellInfo ::= | SEQUENCE { | |
|---|---|---|
| physCellld | , | |
| q-OffsetCell | Q-OffsetRange, | |
| q-RxLevMinOffsetCell | INTEGER (1..8) | OPTIONAL, -- |

Need R

| | | |
|---|---|---|
| q-RxLevMinOffsetCell SUL | INTEGER (1..8) | OPTIONAL, |

-- Need R

| | | |
|---|---|---|
| q-QualMinOffsetCell | INTEGER (1..8) | OPTIONAL, -- |

Need R
...
}

| IntraFreqNeighCellInfo-v1610 ::= | SEQUENCE { | |
|---|---|---|
| ssb-PositionQCL-r16 | SSB-PositionQCL-Relation-r16 | OPTIONAL |

-- Cond SharedSpectrum2
}

| | |
|---|---|
| IntraFreqBlackCellList::= | SEQUENCE (SIZE (1..maxCellBlack)) OF PCI-Range |
| IntraFreqWhiteCellList-r16 ::= | SEQUENCE (SIZE (1..maxCellWhite)) OF PCI-Range |

IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

The SIB4 may include information/parameters for reselecting an NR intra-frequency cell by the terminal 5-01 in the RRC idle mode or the RRC inactive state. For example, one or a plurality of NR inter-frequencies may be broadcasted via the SIB4, and one cell reselection priority configuration information for each NR inter-frequency may be broadcasted. The cell reselection priority configuration information for each NR inter-frequency means the above-mentioned content (for example, cellReselectionPriority and/or cellReselectionSubPriority mapped to each NR inter-frequency), but one cell reselection priority configuration information for each inter-frequency is optionally broadcasted. Specifically, information in Table 4 below may be broadcasted via the SIB4.

TABLE 4

| SIB4 ::= | SEQUENCE { | |
|---|---|---|
| interFreqCarrierFreqList | , | |
| lateNonCriticalExtension | OCTET STRING | OPTIONAL, |

```
  ...,
  [[
```

| | |
|---|---|
| interFreqCarrierFreqList-v1610 | OPTIONAL -- NeedR |

]]
}

| | |
|---|---|
| InterFreqCarrierFreqList ::= | SEQUENCE (SIZE (1..maxFreq)) OF |

InterFreqCarrierFreqInfo
InterFreqCarrierFreqList-v1610 ::= SEQUENCE (SIZE (1..maxFreq)) OF
InterFreqCarrierFreqInfo-v1610

| | |
|---|---|
| InterFreqCarrierFreqInfo ::= | SEQUENCE { |
| dl-CarrierFreq | ARFCN-ValueNR, |
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | | |
|---|---|---|
| smtc | SSB-MTC | OPTIONAL, -- |

Need S

| | |
|---|---|
| ssbSubcarrierSpacing | SubcarrierSpacing, |

| | |
|---|---|
| ssb-ToMeasure | OPTIONAL, -- Need S |

| | |
|---|---|
| deriveSSB-IndexFromCell | BOOLEAN, |

| | |
|---|---|
| ss-RSSI-Measurement | OPTIONAL, |

| | |
|---|---|
| q-RxLevMin | , |
| q-RxLevMinSUL | Q-RxLevMin |

OPTIONAL, -- Need R

| | |
|---|---|
| q-QualMin | OPTIONAL, -- Need S |
| p-Max | OPTIONAL, -- Need S |

| | |
|---|---|
| t-ReselectionNR | T-Reselection, |
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |
| threshX-LowQ | ReselectionThresholdQ |

| | |
|---|---|
| } | OPTIONAL, -- Cond |

RSRQ

| cellReselectionPriority | | OPTIONAL, -- Need R |
|---|---|---|
| cellReselectionSubPriority | | OPTIONAL, -- Need R |
| q-OffsetFreq | Q-OffsetRange | DEFAULT dB0, |

| | |
|---|---|
| interFreqNeighCellList | OPTIONAL, -- Need R |
| interFreqBlackCellList | OPTIONAL, -- Need R |

...
}
InterFreqCarrierFreqInfo-v1610 ::= SEQUENCE {

| | |
|---|---|
| interFreqNeighCellList-v1610 | OPTIONAL, -- Need R |

| | |
|---|---|
| smtc2-LP-r16 | SSB-MTC2-LP-r16 |

OPTIONAL, -- Need R

| | |
|---|---|
| interFreqWhiteCellList-r16 | OPTIONAL, -- Cond |

SharedSpectrum2

| | |
|---|---|
| ssb-PositionQCL-Common-r16 | SSB-PositionQCL-Relation-r16 |

OPTIONAL, -- Cond Shared Spectrum

| | |
|---|---|
| interFreqCAG-CellList-r16 | SEQUENCE (SIZE (1..maxPLMN)) OF |

InterFreqCAG-CellListPerPLMN-r16 OPTIONAL -- Need R
}

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (SIZE (1..maxCellInter)) OF |

InterFreqNeighCellInfo-v1610

| | |
|---|---|
| InterFreqNeighCellInfo ::= | SEQUENCE { |
| physCellId | , |
| q-OffsetCell | Q-OffsetRange, |
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |
| ssb-PositionQCL-r16 | SSB-PositionQCL-Relation-r16 |

OPTIONAL -- Cond SharedSpectrum2
}

| | |
|---|---|
| InterFreqBlackCellList ::= | SEQUENCE (SIZE (1..maxCellBlack)) OF PCI-Range |
| InterFreqWhiteCellList-r16 ::= | SEQUENCE (SIZE (1..maxCellWhite)) OF PCI-Range |

InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

The SIB5 may include information/parameters for reselecting an inter-RAT frequency cell by the terminal 5-01 in the RRC idle mode or the RRC inactive state. For example, one or a plurality of evolved universal terrestrial radio access (EUTRA) frequencies may be broadcasted via the SIB5, and one cell reselection priority configuration information for each EUTRA frequency may be broadcasted. The cell reselection priority configuration information for each EUTRA frequency means the above-mentioned content (for example, cellReselectionPriority and/or cellReselectionSubPriority mapped to each EUTRA frequency), but one cell reselection priority configuration information for each EUTRA frequency is optionally broadcasted. Specifically, information in Table 5 below may be broadcasted via the SIB5.

TABLE 5

| | |
|---|---|
| SIB5 ::= | SEQUENCE { |

| | | |
|---|---|---|
| carrierFreqListEUTRA | OPTIONAL, | -- Need R |

| | |
|---|---|
| t-ReselectionEUTRA | T-Reselection, |

| | | |
|---|---|---|
| t-ReselectionEUTRA-SF | SpeedStateScaleFactors | OPTIONAL, |

-- Need S

| | | |
|---|---|---|
| lateNonCriticalExtension | OCTET STRING | OPTIONAL, |

```
  ...,
  [[
```

| | | |
|---|---|---|
| carrierFreqListEUTRA-vl610 | OPTIONAL | -- Need R |

]]
}

| | |
|---|---|
| CarrierFreqListEUTRA ::= | SEQUENCE (SIZE (1..maxEUTRA-Carrier)) OF |

CarrierFreqEUTRA

| | |
|---|---|
| CarrierFreqListEUTRA-v1610 ::= | SEQUENCE (SIZE (1..maxEUTRA-Carrier)) OF |

CarrierFreqEUTRA-v1610

| | |
|---|---|
| CarrierFreqEUTRA ::= | SEQUENCE { |
| carrierFreq | ARFCN-ValueEUTRA, |

| | | |
|---|---|---|
| eutra-multiBandInfoList | OPTIONAL, | -- Need R |
| eutra-FreqNeighCellList | OPTIONAL, | -- Need R |

| | | |
|---|---|---|
| eutra-BlackCellList | EUTRA-FreqBlackCellList | OPTIONAL, |

-- Need R

| | |
|---|---|
| allowedMeasBandwidth | EUTRA-AllowedMeasBandwidth, |

| | |
|---|---|
| presenceAntennaPort1 | EUTRA-PresenceAntennaPort1, |

| | | |
|---|---|---|
| cellReselectionPriority | OPTIONAL, | -- Need R |
| cellReselectionSubPriority | OPTIONAL, | -- Need R |

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

| | | |
|---|---|---|
| } | OPTIONAL | -- Cond RSRQ |

}
CarrierFreqEUTRA-v1610 ::= SEQUENCE {

| | |
|---|---|
| highSpeedEUTRACarrier-r16 | ENUMERATED {true} |

OPTIONAL -- Need R
}

| | |
|---|---|
| EUTRA-FreqBlackCellList ::= | SEQUENCE (SIZE (1..maxEUTRA-CellBlack)) OF |

EUTRA-PhysCellIdRange

| | |
|---|---|
| EUTRA-FreqNeighCellList ::= | SEQUENCE (SIZE (1..maxCellEUTRA)) OF |

EUTRA-FreqNeighCellInfo

| | |
|---|---|
| EUTRA-FreqNeighCellInfo ::= | SEQUENCE { |

| physCellId | EUTRA-PhysCellId, | |
|---|---|---|
| dummy | EUTRA-Q-OffsetRange, | |
| q-RxLevMinOffsetCell | INTEGER (1..8) | OPTIONAL, - |

- Need R

| | | |
|---|---|---|
| q-QualMinOffsetCell | INTEGER (1..8) | OPTIONAL -- |

Need R
}

The terminal 5-01 in the RRC idle mode or the RRC inactive state may perform a cell reselection evaluation procedure (cell reselection evaluation process). The cell reselection evaluation procedure may mean a series of processes of determining a reselection priority (reselection priorities handling), applying measurement rules for cell re-selection to perform frequency measurement, and evaluating cell reselection criteria to reselect a cell.

In operation 5-25, the terminal 5-01 in the RRC idle mode or the RRC inactive state may determine a reselection priority, based on the system information received in operation 5-20. The terminal 5-01 may determine a reselection priority only for a frequency at which a cell reselection priority value is broadcasted in the system information. With reference to a cell reselection priority value mapped to an NR frequency to which the serving cell 5-02 on which the terminal is currently camping belongs, the terminal 5-01 according to the disclosure may determine whether a cell reselection priority for each NR inter-frequency or inter-RAT frequency has the same cell reselection priority as the NR frequency to which the serving cell 5-02 belongs, whether the cell reselection priority has a higher cell reselection priority than the NR frequency to which the serving cell 5-02 belongs, or whether the cell reselection priority has a lower cell reselection priority than the NR frequency to which the serving cell 5-02 belongs. For example, when it is identified that, in the system information acquired in operation 5-20, the cell reselection priority value mapped to the NR frequency to which the serving cell 5-02 on which the terminal is currently camping belongs is 3, a cell reselection priority value of inter NR frequency 1 is 2, a cell reselection priority value of inter NR frequency 2 is 3, a cell reselection priority value of inter NR frequency 3 is 4, and a cell reselection priority value of EUTRA frequency 1 is 2, the terminal 5-01 may determine the inter NR frequency 1 and EUTRA frequency 1 as a lower reselection priority, determine a cell reselection priority of the inter NR frequency 2 as an equal reselection priority, and determine a cell reselection priority of the inter NR frequency 3 as a higher cell reselection priority.

In operation 5-30, the terminal 5-01 in the RRC idle mode or the RRC inactive state may perform frequency measurement for cell reselection. In this case, in order to minimize battery consumption, the terminal 5-01 may perform frequency measurement by using the following measurement rule according to the cell reselection priority determined in operation 5-25.

The terminal 5-01 may not perform NR intra-frequency measurement when the following condition 1 is satisfied. Otherwise (for example, when the following condition 1 is not satisfied), the terminal 5-01 performs NR intra-frequency measurement.

Condition 1: A reception level (Srxlev) of a serving cell is greater than an SIntraSearchP threshold value and a reception quality (Squal) of the serving cell is greater than an SIntraSearchQ threshold value (Serving cell fulfils Srxlev>SIntraSearchP and Squal>SIntraSearchQ).

For an NR inter-frequency or inter-RAT frequency having a reselection priority higher than an NR frequency of the current serving cell 5-02, the terminal may perform measurement according to the 3GPP TS 38.133 standard.

For an NR inter-frequency having a reselection priority lower than or equal to the NR frequency of the current serving cell 5-02, and an inter-RAT frequency having a reselection priority lower than the NR frequency of the current serving cell 5-02, the terminal 5-01 may not perform measurement when the following condition 2 is satisfied. Otherwise, (for example, when the following condition 2 is not satisfied), the terminal 5-01 measures cells in the NR inter-frequency having the reselection priority lower than or equal to the NR frequency, or measures cells in the inter-RAT frequency having the reselection priority lower than the NR frequency.

Condition 2: A reception level (Srxlev) of a serving cell is greater than an SnonIntraSearchP threshold value and a reception quality (Squal) of the serving cell is greater than an SnonIntraSearchQ threshold value (Serving cell fulfils Srxlev>SnonIntraSearchP and Squal>SnonIntraSearchQ).

For reference, the above-described threshold values (SintraSearchP, SintraSearchQ, SnonIntraSearchP SnonintraSearchQ) may be broadcasted via the system information acquired in operation 5-20.

In operation 5-35, the terminal 5-01 in the RRC idle mode or the RRC inactive state may determine to reselect a cell satisfying cell reselection criteria, based on a value of the measurement performed in operation 5-30. As for the cell reselection criteria, different criteria may be applied according to cell reselection priorities. When multiple cells satisfying the cell re-selection criteria have different cell reselection priorities, reselecting a frequency/RAT cell having a higher cell reselection priority has priority over reselecting a frequency/RAT cell having a lower priority (Cell reselection to a higher priority RAT/frequency shall take precede over a lower priority RAT/frequency if multiple cells of different priorities fulfil the cell reselection criteria). Specifically, the operations of the terminal 5-01 with respect to reselection criteria of an inter-frequency/inter-RAT cell having a higher priority than the frequency of the current serving cell 5-02 are as follows.

### First Operation:

When a threshold value for threshServingLowQ is included in the SIB2 and broadcasted, and a preconfigured time (for example, 1 second) has elapsed since the terminal 5-01 has camped on the current serving cell 5-02, if a signal quality (Squal) of the inter-frequency/inter-RAT cell is greater than a threshold value ThreshX,HighQ during a specific time TreselectionRAT (Squal>ThreshX,HighQ during a time interval TreselectionRAT), the terminal 5-01 performs reselection to the corresponding inter-frequency/inter-RAT cell.

### Second Operation:

When the terminal 5-01 fails to perform the first operation, the terminal performs the second operation.

When a preconfigured time (for example, 1 second) has elapsed since the terminal 5-01 has camped on the current serving cell 5-02, and a reception level (Srxlev) of the inter-frequency/inter-RAT cell is greater than a threshold value ThreshX,HighP during a specific time TreselectionRAT (Srxlev>ThreshX, HighP during a time interval TreselectionRAT), the terminal performs reselection to the corresponding inter-frequency/inter-RAT cell.

The terminal 5-01 performs the first operation or the second operation, based on information in which the TreselectionRAT values, the threshold values (Threh_{X, HighQ}, Thresh_{X, High}), and the reception level (Srxlev) and the signal quality (Squal) of the inter-frequency cell are included in the SIB4 broadcasted from the serving cell 5-02, and performs the first operation or the second operation, based on information in which the TreselectionRAT values, the threshold values (Thresh_{X,HighQ}, Thresh_{X, HighP}), and the reception level (Srxlev) and the signal quality (Squal) of the inter-RAT cell are included in the SIB5 broadcasted from the serving cell 5-02. For example, the SIB4 includes a Q_{qualmin} value or a Qᵣₓₗₑᵥₘᵢₙ value, and based on the values, a signal quality (Squal) or a reception level (Srxlev) of an inter-frequency cell is derived. When a plurality of cells in the NR frequency satisfying a high cell reselection priority exist, the terminal 5-01 may reselect the highest ranked cell from cells satisfying reselection criteria of an intra-frequency/inter-frequency cell having the same priority as the frequency of the current serving cell 5-02 described below.

In addition, the operations of the terminal 5-01 with respect to the reselection criteria of the intra-frequency/inter-frequency cell having the same priority as the frequency of the current serving cell 5-02 are as follows.

### Third Operation:

When a signal quality (Squal) and a reception level (Srxlev) of the intra-frequency/inter-frequency cell are greater than 0, a rank for each cell is derived based on a measurement value (RSRP) (The UE shall perform ranking of all cells that fulfils the cell selection criterion S). Each of ranks of the serving cell 5-02 and a neighboring cell is calculated via Equation 2 below.

Rₛ=Q_{meas,s}+Q_{hyst}

Rₙ=Q_{meas,n}−Qoffset Equation 2

Qmeas,s is an RSRP measurement value of a serving cell, Qmeas,n is an RSRP measurement value of a neighboring cell, Qhyst is a hysteresis value of the serving cell, and Qoffset is an offset between the serving cell and the neighboring cell. A Qhyst value is included in the SIB2, and the corresponding value is commonly used for reselection of the intra-frequency/inter-frequency cell. In the case of reselection of the intra-frequency cell, Qoffset is signaled for each cell, is applied only to an indicated cell, and is included in the SIB3. In the case of reselection of the inter-frequency cell, Qoffset is signaled for each cell, is applied only to an indicated cell, and is included in the SIB4. When the rank of a neighboring cell, obtained by Equation 2 above, is greater than the rank of the serving cell (Rn>Rs), the neighboring cell is reselected as an optimal cell among neighboring cells.

In addition, the operations of the terminal 5-01 with respect to reselection criteria of an inter-frequency/inter-RAT cell having a lower priority than the frequency of the current serving cell 5-02 are as follows.

### Fourth Operation:

When a threshold value for threshServingLowQ is included in the SIB2 and broadcasted, and a preconfigured time (for example, 1 second) has elapsed since the terminal 5-01 has camped on the current serving cell 5-02, if a signal quality (Squal) of the current serving cell 5-02 is less than a threshold value ThreshServing, LowQ (Squal<ThreshServing, LowQ) and a signal quality (Squal) of the inter-frequency/inter-RAT cell is greater than a threshold value ThreshX, LowQ during a specific time TreselectionRAT (Squal>ThreshX,LowQ during a time interval TreselectionRAT), the terminal 5-01 performs reselection to the corresponding inter-frequency/inter-RAT cell.

### Fifth Operation:

When the terminal 5-01 fails to perform the fourth operation, the terminal performs the fifth operation.

When a preconfigured time (for example, 1 second) has elapsed since the terminal 5-01 has camped on the current serving cell 5-02, a reception level (Srxlev) of the current serving cell 5-02 is less than a threshold value ThreshServing, LowP (Srxlev<ThreshServing, LowP), and a reception level (Srxlev) of the inter-frequency/inter-RAT cell is greater than a threshold value ThreshX, LowQ during a specific time TreselectionRAT (Srxlev>ThreshX, LowP during a time interval TreselectionRAT), the terminal 5-01 performs reselection to the corresponding inter-frequency/inter-RAT cell.

The fourth operation or the fifth operation for the inter-frequency cell of the terminal 5-01 is performed based on the threshold values (Thresh_{Serving, LowQ}, Thresh_{Serving, LowP}) included in the SIB2 broadcasted from the serving cell 5-02, and the TreselectionRAT, the threshold values (Threh_{X, LowQ}, Thresh_{X, LowP}), and the reception level (Srxlev) and the signal quality (Squal) of the inter-frequency cell, which are included in the SIB4 broadcasted from the serving cell 5-02, and the fourth operation or the fifth operation for the inter-RAT cell of the terminal 5-01 is performed based on the threshold values (Thresh_{Serving, LowQ}, Thresh_{Serving, LowP}) included in the SIB2 broadcasted from the serving cell, and the Treselection_{RAT}, the threshold values (Thresh_{X,LowQ}, Thresh_{X, LowP}), and the reception level (Srxlev) and the signal quality (Squal) of the inter-RAT cell, which are included in the SIB5 broadcasted from the serving cell. For example, the SIB4 includes a Q_{qualmin} value or a Qᵣₓₗₑᵥₘᵢₙ value, and based on the values, the signal quality (Squal) or the reception level (Srxlev) of the inter-frequency cell is derived. When a plurality of cells in the NR frequency satisfying a high cell reselection priority exist, the terminal 5-01 may reselect the highest ranked cell from cells satisfying reselection criteria of an intra-frequency/inter-frequency cell having the same priority as the frequency of the current serving cell described below.

In operation 5-40, the terminal 5-01 in the RRC idle mode or the RRC inactive state receives system information (for example, MIB or SIB1) broadcasted from a candidate target cell before finally reselecting the candidate target cell, and determines whether a reception level (Srxlev) and a reception quality (Squal) of the candidate target cell fulfill a cell selection criterion called S-criterion (Equation 1) (Srxlev>0 AND Squal>0), based on the received system information. When Equation 1 is satisfied and the candidate target cell is suitable, the terminal 5-01 may reselect the candidate target cell.

According to an embodiment of the disclosure, the characteristics of the NR cell and the terminal may be defined as follows.

1. In a serving cell on which the terminal is currently camping, a cell reselection priority value mapped to an NR frequency to which the serving cell belongs is always broadcasted via system information.

2. When the terminal in the RRC idle mode or the RRC inactive state manages a cell reselection priority (reselection priorities handling), based on the system information, with reference to the cell reselection priority value mapped to the NR frequency to which the serving cell belongs, the terminal may determine whether a cell reselection priority for each NR inter-frequency or inter-RAT frequency has the same cell reselection priority as the NR frequency to which the serving cell belongs, whether the cell reselection priority has a higher cell reselection priority than the NR frequency to which the serving cell belongs, or whether the cell reselection priority has a lower cell reselection priority than the NR frequency to which the serving cell belongs.

3. The terminal in the RRC idle mode or the RRC inactive state may determine whether to measure an NR intra-frequency by comparing a signal strength and signal quality of the serving cell on which the terminal is currently camping with a threshold value.

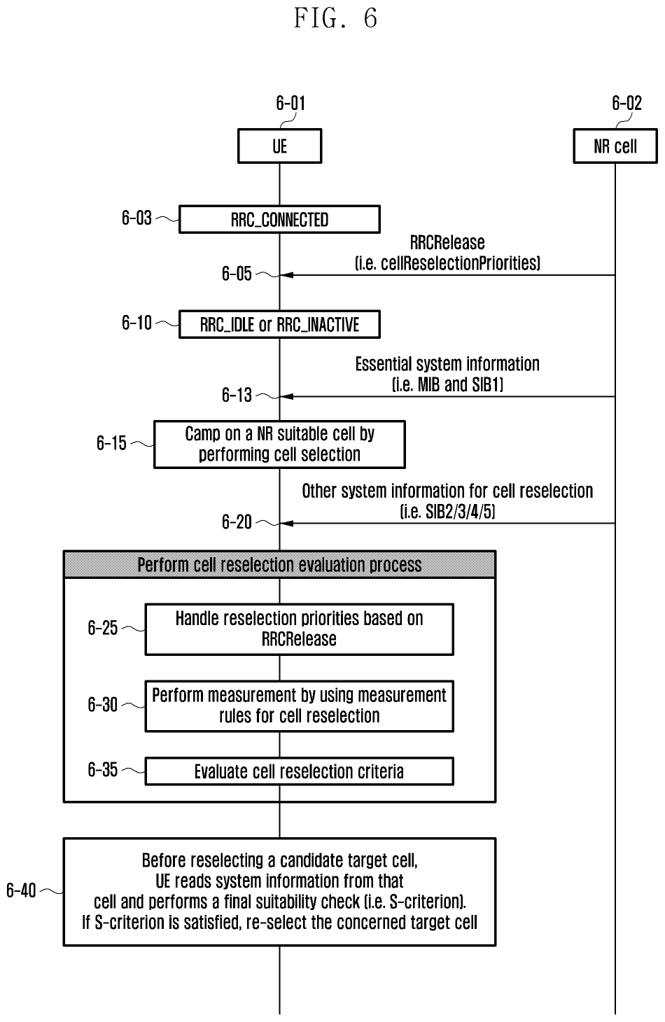

FIG. 6 illustrates that a terminal in an RRC idle mode (RRC_IDLE) or an RRC inactive state (RRC_INACTIVE) in a next-generation mobile communication system performs a cell reselection evaluation procedure, based on a reselection priority provided by an RRC release message, without considering a slice according to an embodiment of the disclosure.

Referring to FIG. 6, a terminal 6-01 may be in an RRC connected mode (RRC_CONNECTED) (operation 6-03).

In operation 6-05, an NR cell 6-02 may transmit an RRC Release message for RRC connection release to the terminal 6-01 in the RRC connected mode. The RRC Release message may include one cell reselection priority configuration information per frequency for each RAT (for example, NR and E-UTRA). For example, the cell reselection information may refer to information included in cellReselectionPriorities. Specifically, the cellReselectionPriorities may include at least one of the following parameters.

FreqPriorityListEUTRA: A list including one or multiple FreqPriorityEUTRAs. Each of the FreqPriorityEUTRAs includes carrierFreq, cellReselectionPriority, cellReselectionSubPriority (optional). The carrierFreq may receive a value of ARFCN-ValueEUTRA indicating an absolute radio frequency channel number (hereinafter referred to as AFRCN), the cellReselectionPriority may receive an integer value (for example, one integer value from 0 to 7), and the cellReselectionSubPriority may receive a decimal value (for example, one decimal value among 0.2, 0.4, 0.6, and 0.8). When both the cellReselectionPriority and cellReselectionSubPriority are signaled, the terminal may derive a cell reselection priority value by adding the two values. For reference, as the cell reselection priority value is higher, the terminal may perform a cell reselection evaluation procedure with the corresponding frequency as a higher priority.

FreqPrioritListNR: A list including one or multiple FreqPriorityNRs. Each of the FreqPriorityNRs includes carrierFreq, cellReselectionPriority, and cellReselectionSubPriority (optional). The carrierFreq may receive a value of ARFCN-ValueNR indicating an absolute radio frequency channel number (hereinafter referred to as AFRCN), the cellReselectionPriority may receive an integer value (for example, one integer value from 0 to 7), and the cellReselectionSubPriority may receive a decimal value (for example, one decimal value among 0.2, 0.4, 0.6, and 0.8). When both the cellReselectionPriority and cellReselectionSubPriority are signaled, the terminal may derive a cell reselection priority value by adding the two values. For reference, as the cell reselection priority value is higher, the terminal may perform a cell reselection evaluation procedure with the corresponding frequency as a higher priority.

T320 timer value (optional)

When the RRC release message received by the terminal 6-01 includes cellReselectionPriorities, the terminal 6-01 may store information included in the cellReselectionPriorities. If the RRC release message includes a T320 timer value, the terminal 6-01 may drive a T320 timer, based on the received T320 timer value. While the T320 timer is running, the terminal 6-01 may perform a cell reselection process, based on cell reselection priority configuration information included in the cellReselectionPriorities of the RRC Release message. For example, the terminal 6-01 may ignore the cell reselection priority configuration information broadcasted via system information. If the RRC release message does not include the T320 timer value, the terminal 6-01 may perform the cell reselection process, based on the cell reselection priority configuration information included in the cellReselectionPriorities when the cellReselectionPriorities are not deleted. If the driven T320 timer expires or the terminal 6-01 deletes the stored cellReselectionPriorities, the terminal 6-01 may perform the cell reselection process, based on the cell reselection priority configuration information broadcasted via the system information as in the above-described embodiment.

In operation 6-10, when the RRC release message received in operation 6-05 includes suspension configuration information (suspendConfig), the terminal 6-01 may transition to an RRC inactive mode. In operation 6-10, when the RRC release message received in operation 6-05 does not include the suspension configuration information, the terminal may transition to an RRC idle mode.

In operation 6-13, the terminal 6-01 in the RRC idle mode or the RRC inactive state may acquire essential system information from the NR cell 6-02. In an embodiment of the disclosure, a master information block (MIB) and system information block 1 (SIB1) may be referred to as essential system information.

In operation 6-15, the terminal 6-01 in the RRC idle mode or the RRC inactive state may perform a cell selection procedure, based on the essential system information acquired in operation 6-13. For example, the terminal 6-01 may find an NR suitable cell belonging to a selected PLMN or SNPN and camp on the corresponding cell. The definition of a suitable cell may refer to the above-described embodiment. The cell on which the terminal 6-01 has camped may be referred to as a serving cell.

In operation 6-20, the terminal 6-01 in the RRC idle mode or the RRC inactive state may acquire system information (for example, SIB2, SIB3, SIB4, and SIB5) including cell reselection information from the serving cell 6-02 in order to perform the cell reselection evaluation procedure. The description of the system information acquired by the terminal 6-01 may refer to the above-described embodiment.

The terminal 6-01 in the RRC idle mode or the RRC inactive state may perform a cell reselection evaluation procedure (cell reselection evaluation process). The cell reselection evaluation procedure may mean a series of processes of determining a reselection priority (reselection priorities handling), applying measurement rules for cell re-selection to perform frequency measurement, and evaluating cell reselection criteria to reselect a cell.

In operation 6-25, the terminal 6-01 in the RRC idle mode or the RRC inactive state may determine a reselection priority, based on the RRC release message received in operation 6-05. The terminal 6-01 may determine a reselection priority only for a frequency for which a cell reselection priority value is configured in the RRC release message. When the terminal 6-01 camps on a suitable cell (that is, when the terminal is in a camped normally state), and when reselection priority values exist only for the remaining frequencies other than the current serving frequency, a reselection priority value of the current serving frequency may be configured to be lower than reselection priority values configured in the RRC release message by a base station. For example, the current frequency may be determined as the lowest reselection priority. With reference to a cell reselection priority value mapped to an NR frequency to which the serving cell 6-02 on which the terminal is currently camping belongs, the terminal 6-01 according to an embodiment of the disclosure may determine whether a cell reselection priority for each NR inter-frequency or inter-RAT frequency has the same cell reselection priority as the NR frequency to which the serving cell 6-02 belongs, whether the cell reselection priority has a higher cell reselection priority than the NR frequency to which the serving cell 6-02 belongs, or whether the cell reselection priority has a lower cell reselection priority than the NR frequency to which the serving cell 6-02 belongs. For example, when, in the RRC release message received in operation 6-05, the cell reselection priority value mapped to the NR frequency to which the serving cell 6-02 on which the terminal is currently camping belongs is 3, a cell reselection priority value of inter NR frequency 1 is 2, a cell reselection priority value of inter NR frequency 2 is 3, a cell reselection priority value of inter NR frequency 3 is 4, and a cell reselection priority value of EUTRA frequency 1 is 2, the terminal 6-01 may determine the inter NR frequency 1 and EUTRA frequency 1 as a lower reselection priority, determine a cell reselection priority of the inter NR frequency 2 as an equal reselection priority, and determine a cell reselection priority of the inter NR frequency 3 as a higher cell reselection priority.

In operation 6-30, the terminal 6-01 in the RRC idle mode or the RRC inactive state may perform frequency measurement for cell reselection. In this case, in order to minimize battery consumption, the terminal 6-01 may perform frequency measurement by using the following measurement rule according to the cell reselection priority determined in operation 6-25.

The terminal 6-01 may not perform NR intra-frequency measurement when the following condition 1 is satisfied. Otherwise (for example, when the following condition 1 is not satisfied), the terminal 6-01 performs NR intra-frequency measurement.

Condition 1: A reception level (Srxlev) of a serving cell is greater than an SIntraSearchP threshold value and a reception quality (Squal) of the serving cell is greater than an SIntraSearchQ threshold value (Serving cell fulfils Srxlev>SIntraSearchP and Squal>SIntraSearchQ).

For an NR inter-frequency or inter-RAT frequency having a reselection priority higher than an NR frequency of the current serving cell, the terminal may perform measurement according to the 3GPP TS 38.133 standard.

For an NR inter-frequency having a reselection priority lower than or equal to the NR frequency of the current serving cell, and an inter-RAT frequency having a reselection priority lower than the NR frequency of the current serving cell, the terminal may not perform measurement when the following condition 2 is satisfied. Otherwise, (for example, when the following condition 2 is not satisfied), the terminal measures cells in the NR inter-frequency having the reselection priority lower than or equal to the NR frequency, or measures cells in the inter-RAT frequency having the reselection priority lower than the NR frequency.

Condition 2: A reception level (Srxlev) of a serving cell is greater than an SnonIntraSearchP threshold value and a reception quality (Squal) of the serving cell is greater than an SnonIntraSearchQ threshold value (Serving cell fulfils Srxlev>SnonIntraSearchP and Squal>SnonIntraSearchQ).

For reference, the above-described threshold values (SintraSearchP, SintraSearchQ, SnonIntraSearchP SnonintraSearchQ) may be broadcasted via the system information acquired in operation 6-20.

In operation 6-35, the terminal 6-01 in the RRC idle mode or the RRC inactive state may determine to reselect a cell satisfying cell reselection criteria, based on a value of the measurement performed in operation 6-30. As for the cell reselection criteria, different criteria may be applied according to cell reselection priorities. When multiple cells satisfying the cell re-selection criteria have different cell reselection priorities, reselecting a frequency/RAT cell having a higher cell reselection priority has priority over reselecting a frequency/RAT cell having a lower priority (Cell reselection to a higher priority RAT/frequency shall take precede over a lower priority RAT/frequency if multiple cells of different priorities fulfil the cell reselection criteria). Specifically, the operations of the terminal 6-01 with respect to reselection criteria of an inter-frequency/inter-RAT cell having a higher priority than the frequency of the current serving cell are as follows.

### First Operation:

When a threshold value for threshServingLowQ is included in the SIB2 and broadcasted, and a preconfigured time (for example, 1 second) has elapsed since the terminal 6-01 has camped on the current serving cell 6-02, if a signal quality (Squal) of the inter-frequency/inter-RAT cell is greater than a threshold value ThreshX,HighQ during a specific time TreselectionRAT (Squal>ThreshX,HighQ during a time interval TreselectionRAT), the terminal 6-01 performs reselection to the corresponding inter-frequency/inter-RAT cell.

### Second Operation:

When the terminal 6-01 fails to perform the first operation, the terminal performs the second operation.

When a preconfigured time (for example, 1 second) has elapsed since the terminal 6-01 has camped on the current serving cell, and a reception level (Srxlev) of the inter-frequency/inter-RAT cell is greater than a threshold value ThreshX,HighP during a specific time TreselectionRAT (Srxlev>ThreshX, HighP during a time interval TreselectionRAT), the terminal 6-01 performs reselection to the corresponding inter-frequency/inter-RAT cell.

The terminal 6-01 performs the first operation or the second operation, based on information in which the TreselectionRAT values, the threshold values (Threh_{X, HighQ}, Thresh_{X, High}), and the reception level (Srxlev) and the signal quality (Squal) of the inter-frequency cell are included in the SIB4 broadcasted from the serving cell 6-02, and performs the first operation or the second operation, based on information in which the Treselection_{RAT} values, the threshold values (Thresh_{X,HighQ}, Thresh_{X, HighP}), and the reception level (Srxlev) and the signal quality (Squal) of the inter-RAT cell are included in the SIB5 broadcasted from the serving cell 6-02. For example, the SIB4 includes a Q_{qualmin} value or a Qᵣₓₗₑᵥₘᵢₙ value, and based on the values, the signal quality (Squal) or the reception level (Srxlev) of the inter-frequency cell is derived. When a plurality of cells in the NR frequency satisfying a high cell reselection priority exist, the terminal 6-01 may reselect the highest ranked cell from cells satisfying reselection criteria of an intra-frequency/inter-frequency cell having the same priority as the frequency of the current serving cell 6-02 described below.

In addition, the operations of the terminal 6-01 with respect to the reselection criteria of the intra-frequency/inter-frequency cell having the same priority as the frequency of the current serving cell 6-02 are as follows.

### Third Operation:

When a signal quality (Squal) and a reception level (Srxlev) of the intra-frequency/inter-frequency cell are greater than 0, a rank for each cell is derived based on a measurement value (RSRP) (The UE shall perform ranking of all cells that fulfils the cell selection criterion S). Each of ranks of the serving cell and a neighboring cell is calculated via Equation 3 below.

Rₛ=Q_{meas,s}+Q_{hyst}

Rₙ=Q_{meas,n}−Qoffset Equation 3

Qmeas,s is an RSRP measurement value of a serving cell, Qmeas,n is an RSRP measurement value of a neighboring cell, Qhyst is a hysteresis value of the serving cell, and Qoffset is an offset between the serving cell and the neighboring cell. A Qhyst value is included in the SIB2, and the corresponding value is commonly used for reselection of the intra-frequency/inter-frequency cell. In the case of reselection of the intra-frequency cell, Qoffset is signaled for each cell, is applied only to an indicated cell, and is included in the SIB3. In the case of reselection of the inter-frequency cell, Qoffset is signaled for each cell, is applied only to an indicated cell, and is included in the SIB4. When the rank of a neighboring cell, obtained by Equation 3 above, is greater than the rank of the serving cell (Rn>Rs), the neighboring cell is reselected as an optimal cell among neighboring cells.

In addition, the operations of the terminal 6-01 with respect to reselection criteria of an inter-frequency/inter-RAT cell having a lower priority than the frequency of the current serving cell 6-02 are as follows.

### Fourth Operation:

When a threshold value for threshServingLowQ is included in the SIB2 and broadcasted, and a preconfigured time (for example, 1 second) has elapsed since the terminal 6-01 has camped on the current serving cell 6-02, if a signal quality (Squal) of the current serving cell 6-02 is less than a threshold value ThreshServing, LowQ (Squal<ThreshServing, LowQ) and a signal quality (Squal) of the inter-frequency/inter-RAT cell is greater than a threshold value ThreshX, LowQ during a specific time TreselectionRAT (Squal>ThreshX,LowQ during a time interval TreselectionRAT), the terminal 6-01 performs reselection to the corresponding inter-frequency/inter-RAT cell.

### Fifth Operation:

When the terminal 6-01 fails to perform the fourth operation, the terminal performs the fifth operation.

When a preconfigured time (for example, 1 second) has elapsed since the terminal 6-01 has camped on the current serving cell 6-02, a reception level (Srxlev) of the current serving cell 6-02 is less than a threshold value ThreshServing, LowP (Srxlev<ThreshServing, LowP), and a reception level (Srxlev) of the inter-frequency/inter-RAT cell is greater than a threshold value ThreshX, LowQ during a specific time TreselectionRAT (Srxlev>ThreshX,LowP during a time interval TreselectionRAT), the terminal 6-01 performs reselection to the corresponding inter-frequency/inter-RAT cell.

The fourth operation or the fifth operation for the inter-frequency cell of the terminal 6-01 is performed based on the threshold values (Thresh_{Serving, LowQ}, Thresh_{Serving, LowP}) included in the SIB2 broadcasted from the serving cell 6-02, and the Treselection_{RAT}, the threshold values (Threh_{X, LowQ}, Thresh_{X, Lowp}), and the reception level (Srxlev) and the signal quality (Squal) of the inter-frequency cell, which are included in the SIB4 broadcasted from the serving cell 6-02, and the fourth operation or the fifth operation for the inter-RAT cell of the terminal 6-01 is performed based on the threshold values (Thresh_{Serving, LowQ}, Thresh_{Serving, LowP}) included in the SIB2 broadcasted from the serving cell 6-02, and the Treselection_{RAT}, the threshold values (Thresh_{X,LowQ}, Thresh_{X, LowP}), and the reception level (Srxlev) and the signal quality (Squal) of the inter-RAT cell, which are included in the SIB5 broadcasted from the serving cell 6-02. For example, the SIB4 includes a Q_{qualmin} value or a Qᵣₓₗₑᵥₘᵢₙ value, and based on the values, the signal quality (Squal) or the reception level (Srxlev) of the inter-frequency cell is derived. If a plurality of cells in the NR frequency satisfying a high cell reselection priority exist, the terminal 6-01 may reselect the highest ranked cell from cells satisfying reselection criteria of an intra-frequency/inter-frequency cell having the same priority as the frequency of the current serving cell 6-02 described below.

In operation 6-40, the terminal 6-01 in the RRC idle mode or the RRC inactive state receives system information (for example, MIB or SIB1) broadcasted from a candidate target cell before finally reselecting the candidate target cell, and determines whether a reception level (Srxlev) and a reception quality (Squal) of the candidate target cell fulfill a cell selection criterion called S-criterion (Equation 1) (Srxlev>0 AND Squal>0), based on the received system information. When Equation 1 is satisfied and the candidate target cell is suitable, the terminal 6-01 may reselect the candidate target cell.

The characteristics of the NR cell and the terminal according to an embodiment of the disclosure may be defined as follows.

The terminal in the RRC idle mode or the RRC inactive state may manage a cell reselection priority (reselection priorities handling), based on a RRC release message. For example, while a T320 timer is running or when the T320 timer is not configured but cell reselection priority information is configured in the RRC release message, the terminal may manage a cell reselection priority (reselection priorities handling), based on the RRC release message. When the T320 timer expires or the terminal releases the cell reselection priority information configured in the RRC release message received from a base station, the terminal may manage a cell reselection priority (reselection priorities handling), based on system information according to the above-described embodiment.

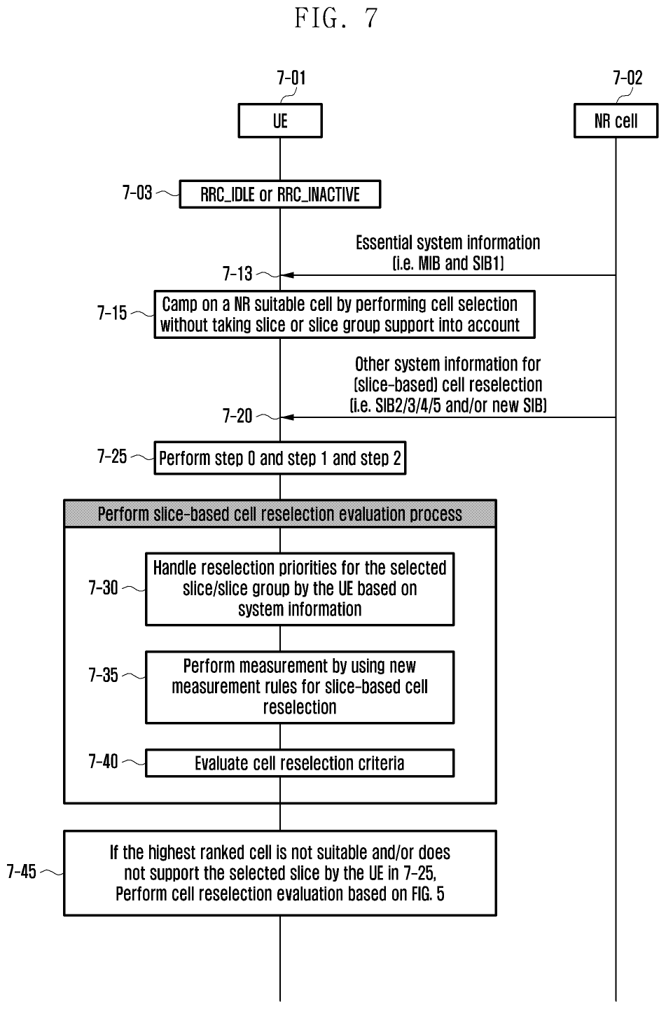

FIG. 7 illustrates that a terminal in an RRC idle mode (RRC_IDLE) or an RRC inactive state (RRC_INACTIVE) in a next-generation mobile communication system applies slice-based cell reselection priority (slice-based reselection priorities) information broadcasted via system information to fall back to a cell reselection evaluation procedure without consideration of a slice in a slice-based cell reselection evaluation procedure, and to reselect a cell according to an embodiment of the disclosure.

In an embodiment of the disclosure, a serving cell on which the terminal in the RRC idle mode (RRC_IDLE) or the RRC inactive state (RRC_INACTIVE) is camping may broadcast a single-network slice assistance information (S-NSASSI) (hereinafter, referred to as a slice) or an S-NASSI list (hereinafter, referred to as a slice group) supportable for each NR frequency or for each of one or multiple neighboring cells operating at each NR frequency via system information. For reference, in the system information, Slice/ServiceType (SST) or SST and Slice/Slice Type and Slice Differentiator (SST-SD) may be broadcasted to indicate each slice, or an index indicating a specific S-NASSI may be broadcasted. In the system information, a list of SSTs or SSTs and SST-SDs may be broadcasted to indicate each slice group, or an index indicating a specific slice group may be broadcasted. The slice index or the slice group index may be provided by a terminal upper layer device (a UE NAS layer or upper layer) to a terminal radio access layer device (a UE AS layer) via NAS signaling or by terminal implementation.

In an embodiment of the disclosure, the serving cell on which the terminal in the RRC idle mode or the RRC inactive state is camping may broadcast cell reselection priority configuration information for slice mapped to a slice or a slice group for each NR frequency via system information. For example, in relation to the cell reselection priority configuration information for slice, the serving cell may independently broadcast the above-described cell reselection priority configuration information.

In an embodiment of the disclosure, the terminal in the RRC idle mode or the RRC inactive state may support both the cell reselection evaluation procedure (FIG. 5) and the slice-based cell reselection evaluation procedure described above. The slice-based cell reselection evaluation procedure may largely mean the following series of processes.
Step 0: NAS layer at UE provides slice information to AS layer at UE, including slice priority(ies) per each slice or each slice group.
Step 1: AS sorts slice(s) or slice group(s) in priority order starting with highest priority slice(s) or slice group(s).
Step 2: Select slice(s) or slice group(s) in priority order starting with the highest priority slice(s) or slice group(s).
Step 3: For the selected slice(s) or slice group(s) assign priority to frequencies received from network.
Step 4: Perform modified measurements or starting from the highest priority frequency(ies), perform modified measurement
Step 5: If the highest ranked cell is determined according to cell reselection criteria (for example, FIG. 5) and suitable and supports the selected slice in step 2 then camp on the cell and exit this sequence of operation;
Step 6: If there are remaining frequencies then go back to step 4.
Step 7: If the end of the slice list has not been reached go back to step 2.

Note that UE may not need to perform step 6 and/or step 7. In addition, step 1 and step 2 can be simplified as “select the highest priority slice(s) or slice group(s).”

Referring to FIG. 7, a terminal 7-01 may be in an RRC idle mode (RRC_IDLE) or an RRC inactive state (RRC_INACTIVE) (operation 7-03).

In operation 7-13, the terminal 7-01 in the RRC idle mode or the RRC inactive state may acquire essential system information from an NR cell 7-02. In an embodiment of the disclosure, a master information block (MIB) and system information block 1 (SIB1) may be referred to as essential system information.

In operation 7-15, the terminal 7-01 in the RRC idle mode or the RRC inactive state may perform a cell selection procedure, based on the essential system information acquired in operation 7-13. The cell selection procedure is the same as that in the above-described embodiment (FIG. 5). For example, the cell selection procedure may mean that the terminal 7-01 performs the cell selection procedure as in the above-described embodiment without considering whether a slice or a slice group is supported.

In operation 7-20, the terminal 7-01 in the RRC idle mode or the RRC inactive state may acquire system information (for example, SIB2, SIB3, SIB4, SIB5, or new SIB) including cell reselection information from the serving cell 7-02 in order to perform the cell reselection evaluation procedure of the above-described embodiment (FIG. 5) and/or perform a slice-based cell reselection evaluation procedure. The cell reselection information for the cell reselection evaluation procedure broadcasted via the system information may follow the above-described embodiment of FIG. 5. An embodiment of the disclosure proposes to additionally include new cell reselection information for a slice-based cell reselection evaluation procedure in the system information.

Specifically, the following configurations may be considered for the SIB2, SIB3, and SIB4.
SIB2: A slice (indicator) or a slice group (indicator) which is supportable at a serving NR frequency may be broadcasted. In addition, slice-based cell reselection priority configuration information mapped to the serving NR frequency may be selectively included. For example, the slice-based cell reselection priority configuration information may mean cellReselectionPriorityForSlice and cellReselectionSubPriorityForSlice, a cellReselectionPriorityForSlice value may indicate an integer value as in the above-described embodiment of the disclosure, and a cellReselectionSubPriorityForSlice value may indicate a decimal value as in the above-described embodiment. If the slice (indicator) or the slice group (indicator) which is supportable at the serving NR frequency is broadcasted, in the SIB2, a slice (or slice indicator) or a slice group (or slice group indicator) additionally supported at the serving NR frequency may include an indicator that all neighboring cells operating at the serving NR frequency can be supported, or a neighboring cell list may not be included in the serving NR frequency to indicate that all neighboring cells operating at the serving NR frequency can be supported. The terminal 7-01 may perform cell reselection evaluation procedure based on slice based on all neighboring cells at the serving NR frequency. If only specific neighboring cells among all neighboring cells operating at the serving NR frequency support the slice (indicator) or the slice group (indicator), a neighboring cell list for indicating the neighboring cells may be broadcasted via the SIB2. The terminal 7-01 may perform the cell reselection evaluation procedure based on slice based on only the neighboring cell list broadcasted at the serving NR frequency. A list of neighboring cells which do not support the slice (indicator) or the slice group (indicator) may be broadcasted via the SIB2. The terminal 7-01 may perform the cell reselection evaluation procedure based on slice on neighboring cells other than the neighboring cell list broadcasted at the serving NR frequency. For reference, the content described above may be applied for each PLMN and/or for each slice (indicator) or slice group (indicator).
SIB3: A slice (indicator) or a slice group (indicator) which is supportable at a serving NR frequency may be broadcasted. In addition, slice-based cell reselection priority configuration information mapped to the serving NR frequency may be selectively included. If the slice (indicator) or the slice group (indicator) which is supportable at the serving NR frequency is broadcasted, in the SIB3, a slice (or slice indicator) or a slice group (or slice group indicator) additionally supported at the serving NR frequency may include an indicator that all neighboring cells operating at the serving NR frequency can be supported, or a neighboring cell list may not be included in the serving NR frequency to indicate that all neighboring cells operating at the serving NR frequency can be supported. The terminal 7-01 may perform a cell reselection evaluation procedure based on slice based on all neighboring cells at the serving NR frequency. If via the SIB3, only specific one or multiple neighboring cells additionally support the slice (indicator) or the slice group (indicator) at the serving NR frequency, the corresponding neighboring cell list may be broadcasted. The terminal 7-01 may perform the cell reselection evaluation procedure based on slice based on only the neighboring cell list broadcasted at the serving NR frequency. When the serving cell 7-02 broadcasts the SIB3, the neighboring cell list may be broadcasted as a PCI list or, for signaling optimization, an identifier for each cell may be broadcasted as an index to indicate a neighboring cell. For example, the index may indicate a specific order in the neighboring cell list of the related art (for example, intraFreqNeighCellList or intraFreqWhiteCellList or intraFreqBlackCellList) included in the SIB3. A corresponding list of neighboring cells which do not support the slice (indicator) or the slice group (indicator) may be broadcasted. The terminal 7-01 may perform the cell reselection evaluation procedure based on slice on neighboring cells other than the neighboring cell list broadcasted at the serving NR frequency. When the serving cell 7-02 broadcasts the SIB3, the neighboring cell list may be broadcasted as a PCI list or, for signaling optimization, an identifier for each cell may be broadcasted as an index to indicate a neighboring cell. For example, the index may indicate a specific order in the neighboring cell list of the related art (for example, intraFreqNeighCellList or intraFreqWhiteCellList or intraFreqBlackCellList) included in the SIB3. For reference, the content described above may be applied for each PLMN and/or for each slice (indicator) or slice group (indicator).
SIB4: A slice (indicator) or a slice group (indicator) which is supportable for each NR inter-frequency may be broadcasted. In addition, slice-based cell reselection priority configuration information mapped to each NR inter-frequency may be selectively included. If a slice (indicator) or a slice group (indicator) which is supportable at a specific NR inter-frequency is broadcasted, an indicator indicating that all neighboring cells operating at the corresponding NR inter-frequency can support the slice (indicator) or the slice group (indicator) is included, or a list of neighboring cells operating at the corresponding NR inter-frequency may not be included in order to indicate that all neighboring cells operating at the corresponding NR inter-frequency can support the slice (indicator) or the slice group (indicator). The terminal 7-01 may perform a cell reselection evaluation procedure based on slice based on all neighboring cells at the corresponding NR inter-frequency. If a slice (indicator) or a slice group (indicator) which is supportable at the NR inter-frequency is broadcasted, and only specific one or multiple neighboring cells operating at the corresponding NR inter-frequency support the slice (indicator) or the slice group (indicator), the one or multiple neighboring cells may be included. The terminal 7-01 may perform the cell reselection evaluation procedure based on slice based on only the neighboring cell list broadcasted at the corresponding NR inter-frequency. When the serving cell 7-02 broadcasts the SIB4, the neighboring cell list may be broadcasted as a PCI list or, for signaling optimization, an identifier for each cell may be broadcasted as an index to indicate a neighboring cell. For example, the index may indicate a specific order in the neighboring cell list of the related art (for example, interFreqNeighCellList or interFreqWhiteCellList or interFreqBlackCellList) included in the SIB4. A corresponding neighboring cell which does not support the slice (indicator) or the slice group (indicator) may be broadcasted. The terminal 7-01 may perform the cell reselection evaluation procedure based on slice on neighboring cells other than the neighboring cell list broadcasted at the corresponding NR inter-frequency. When the serving cell 7-02 broadcasts the SIB4, the neighboring cell list may be broadcasted as a PCI list or, for signaling optimization, an identifier for each cell may be broadcasted as an index to indicate a neighboring cell. For example, the index may indicate a specific order in the neighboring cell list of the related art (for example, intraFreqNeighCellList or intraFreqWhiteCellList or intraFreqBlackCellList) included in the SIB3. For reference, the content described above may be applied for each PLMN and/or for each slice (indicator) or slice group (indicator).
New SIB: The contents described above in the SIB2/3/4 may be broadcasted via new SIB.

In operation 7-25, the terminal 7-01 in the RRC idle mode or the RRC inactive state supporting the slice-based cell reselection evaluation procedure may perform the following process.
Step 0: NAS layer at UE provides slice information to AS layer at UE, including slice priority(ies) per each slice or each slice group.
Step 1: AS sorts slice(s) or slice group(s) in priority order starting with highest priority slice(s) or slice group(s).
Step 2: Select slice(s) or slice group(s) in priority order starting with the highest priority slice(s) or slice group(s).

For reference, the terminal 7-01 may perform select the highest priority slice(s) or slice group(s) without performing Step 1 and Step 2. Alternatively, the terminal 7-01 may perform Step 1 and Step 2 before operation 7-25.

The terminal 7-01 in the RRC idle mode or the RRC inactive state supporting the slice-based cell reselection evaluation procedure may perform the slice-based cell reselection evaluation procedure when slice (or slice group) information selected in operation 7-25 is broadcasted to the system information received in operation 7-20. The slice-based cell reselection evaluation procedure may refer to a series of processes of determining a slice-based reselection priority, applying measurement rules for slice-based cell reselection to perform frequency measurement, and evaluating the cell reselection criteria of the above-described embodiment to reselect a cell supporting the slice or the slice group selected in operation 7-25. For reference, the terminal 7-01 in the RRC idle mode or the RRC inactive state supporting the slice-based cell reselection evaluation procedure may perform the cell reselection evaluation procedure according to the above-described embodiment (FIG. 5) when the slice (or slice group) information selected in operation 7-25 is not broadcasted to the system information received in operation 7-20.

In operation 7-30, the terminal 7-01 in the RRC idle mode or the RRC inactive state supporting the slice-based cell reselection evaluation procedure may determine the slice-based reselection priority, based on the system information received in operation 7-20. The terminal 7-01 may determine the slice-based reselection priority only for a frequency at which a slice-based reselection priority value mapped to the slice (or slice group) selected in operation 7-25 is broadcasted to the system information. Unlike the above-described embodiment (FIG. 5), the slice or the slice group selected by the terminal 7-01 may not be supported at the serving NR frequency at which the serving cell 7-02 according to the disclosure operates. For example, the serving NR frequency at which the serving cell 7-02 operates does not support the slice (or slice group) itself or does not support the slice (or slice group) selected by the terminal 7-01, a slice reselection priority value mapped to the slice or the slice group selected by the terminal 7-01 may not be broadcasted. Therefore, it may not be possible to determine a slice-based reselection priority for each NR inter-frequency with reference to the slice-based reselection priority value mapped to the serving NR frequency to which the serving cell 7-02 belongs. The terminal 7-01 in the RRC idle mode or the RRC inactive state supporting the slice-based cell reselection evaluation procedure according to the disclosure applies one of the following operations when the slice (or slice group) selected by the terminal 7-01 via the system information received in operation 7-20 is not supported at the serving NR frequency (or the slice reselection priority value mapped to the NR frequency for the slice (or slice group) selected by the terminal is not broadcasted), and the slice reselection priority value mapped to the slice (or slice group) selected by the terminal 7-01 is broadcasted at least one NR inter-frequency. For reference, a slice reselection priority refers to a reselection priority mapped to an NR frequency.

Operation 1: The terminal 7-01 may apply a slice reselection priority value received via system information for each NR inter-frequency supporting a slice or a slice group selected by the terminal 7-01. In addition, each NR inter-frequency to which a slice reselection priority value is applied may be determined as a high slice reselection priority. The high slice reselection priority may mean a higher slice reselection priority than the serving NR frequency.

Operation 2: The terminal 7-01 may apply a slice reselection priority value received via system information for each NR inter-frequency supporting a slice or a slice group selected by the terminal 7-01. The terminal 7-01 may apply a slice reselection priority of a serving NR frequency to a lower priority than that to which the slice reselection priority value received via the system information for each NR inter-frequency is applied, or apply the slice reselection priority to the lowest slice reselection priority value. Therefore, the terminal 7-01 may determine each NR inter-frequency to which a slice reselection priority value is applied as a high slice reselection priority.

Operation 3: The terminal 7-01 may apply a slice reselection priority value received via system information for each NR inter-frequency supporting a slice or a slice group selected by the terminal 7-01. The terminal 7-01 may apply a reselection priority value mapped to a serving frequency (a reselection priority value mapped to a serving frequency in the embodiment of FIG. 5) as a slice reselection priority value. The terminal 7-01 compares whether the applied slice reselection priority value of each NR inter-frequency is greater than, equal to, or lower than a slice reselection priority value of a serving frequency with reference to the slice reselection priority value applied to the serving frequency, so as to determine a slice reselection priority of each NR inter-frequency.

Operation 4: The terminal 7-01 may apply a slice reselection priority value received via system information for each NR inter-frequency supporting a slice or a slice group selected by the terminal 7-01. The terminal 7-01 may apply, to a serving NR frequency, the smallest slice reselection priority value, the largest slice reselection priority value, or a specific slice reselection priority value among slice reselection priority values mapped to a slice or a slice group supported at the serving NR frequency, not the slice or the slice group selected by the terminal 7-01. The terminal 7-01 compares whether the applied slice reselection priority value of each NR inter-frequency is greater than, equal to, or lower than a slice reselection priority value of a serving frequency with reference to the slice reselection priority value applied to the serving frequency, so as to determine a slice reselection priority of each NR inter-frequency.

Operation 5: The terminal 7-01 may apply a slice reselection priority value received via system information for each NR inter-frequency supporting a slice or a slice group selected by the terminal 7-01. The terminal 7-01 may apply a slice reselection priority value with an NR serving frequency of 0. Therefore, the terminal 7-01 may determine each NR inter-frequency to which a slice reselection priority value is applied as a high slice reselection priority.

In operation 7-35, the terminal 7-01 in the RRC idle mode or the RRC inactive state supporting the slice-based cell reselection evaluation procedure may perform frequency measurement to reselect a cell supporting the slice or the slice group selected by the terminal 7-01. An embodiment of the disclosure proposes that the terminal 7-01 performs frequency measurement by using the following measurement rule. For reference, the terminal 7-01 has a feature which can perform measurement on only a frequency supporting the slice or the slice group selected by the terminal 7-01. An inter-RAT frequency may be measured according to the above-described embodiment (FIG. 5).
If the slice or the slice group selected by the terminal 7-01 is not supported at an NR serving frequency or if a slice reselection priority is not applied to the NR serving frequency, NR Intra-frequency measurement is not performed.
If the slice or the slice group selected by the terminal 7-01 is supported at the NR serving frequency or if the terminal 7-01 applies the slice reselection priority to the NR serving frequency at the NR serving frequency, the terminal 7-01 may not perform NR intra-frequency measurement when the following condition 1 is satisfied. Otherwise (for example, when the following condition 1 is not satisfied), the terminal 7-01 performs NR intra-frequency measurement.
Condition 1: A reception level (Srxlev) of a serving cell is greater than an SIntraSearchP threshold value and a reception quality (Squal) of the serving cell is greater than an SIntraSearchQ threshold value (Serving cell fulfils Srxlev>SIntraSearchP and Squal>SIntraSearchQ).
If an indicator to measure an NR serving frequency which does not support the slice or the slice group selected by the terminal 7-01 is broadcasted to system information, the terminal 7-01 may measure the NR serving frequency according to the above-described embodiment.

For an NR inter-frequency or inter-RAT frequency having a slice reselection priority higher than an NR frequency of the current serving cell 7-02, the terminal 7-01 may perform measurement according to the 3GPP TS 38.133 standard.

For an NR inter-frequency having a slice reselection priority lower than or equal to the NR frequency of the current serving cell 7-02, the terminal 7-01 may not perform measurement when the following condition 2 is satisfied. Otherwise, (for example, when the following condition 2 is not satisfied), the terminal 7-01 measures cells in the NR inter-frequency having the slice reselection priority lower than or equal to the NR frequency.
Condition 2: A reception level (Srxlev) of a serving cell is greater than an SnonIntraSearchP threshold value and a reception quality (Squal) of the serving cell is greater than an SnonIntraSearchQ threshold value (Serving cell fulfils Srxlev>SnonIntraSearchP and Squal>SnonIntraSearchQ).

For reference, the above-described threshold values (SintraSearchP, SintraSearchQ, SnonIntraSearchP SnonintraSearchQ) may be broadcasted via the system information acquired in operation 7-20.

In operation 7-40, the terminal 7-01 in the RRC idle mode or the RRC inactive state may determine to reselect a cell satisfying cell reselection criteria, based on a value of the measurement performed in operation 7-35. The above-described embodiment may be followed based on the slice reselection priority. When, in operation 7-40, the highest ranked cell is not suitable and/or the slice or the slice group selected in operation 7-20 is not supported, and when the terminal 7-01 has determined the slice reselection priority in operation 7-30 but a frequency which has not been measured exists, the terminal 7-01 may perform again from operation 7-35. Alternatively, the terminal 7-01 may perform again from operation 7-30 for a slice or a slice group having the second highest priority in operation 7-25.

In operation 7-45, when the highest ranked cell is not suitable in operation 7-40 and/or the terminal 7-01 in the RRC idle mode or the RRC inactive state cannot reselect a cell supporting the slice or the slice group selected in operation 7-20, the terminal 7-01 may reselect the cell by performing the cell reselection evaluation procedure, based on the reselection priority broadcasted via the system information, without considering a slice according to the above-described embodiment (FIG. 5). For example, when the terminal 7-01 fails to reselect the cell via the slice-based cell reselection procedure, the terminal 7-01 may reselect the cell by performing the cell reselection procedure which does not consider a slice.

The characteristics of the NR cell and the terminal according to an embodiment of the disclosure may be defined as follows.

1. In a serving cell on which the terminal is currently camping or a serving NR frequency, a slice reselection priority value mapped to a slice (or slice group) selected by the terminal is not always broadcasted via system information.

2. The terminal in the RRC idle mode or the RRC inactive state supporting the slice-based cell reselection evaluation procedure may determine a slice-based cell reselection priority, based on system information. If a serving NR frequency does not support a slice or a slice group selected by the terminal, or a slice-based cell reselection priority value mapped to the serving NR frequency does not exist in the slice or the slice group selected by the terminal and the slice-based cell reselection priority value mapped to the slice or the slice group selected by the terminal is broadcasted via the system information in at least one NR inter-frequency, the terminal may determine the serving NR frequency as the lowest reselection priority or may determine each NR inter-frequency supporting the slice or the slice group selected by the terminal as a high reselection priority. If the serving NR frequency supports the slice or the slice group selected by the terminal, in the same manner as in the above-described embodiment of the disclosure, a reselection priority of each NR inter-frequency supporting the slice or the slice group selected by the terminal may be determined with reference to the serving NR frequency (slice-based reselection priority value).

3. If the terminal in the RRC idle mode or the RRC inactive state supporting the slice-based cell reselection evaluation procedure has performed the slice-based cell reselection procedure, based on system information, but fails to reselect a cell, the terminal may reselect the cell by performing a cell reselection procedure, based on the system information, without considering a slice according to the above-described embodiment.

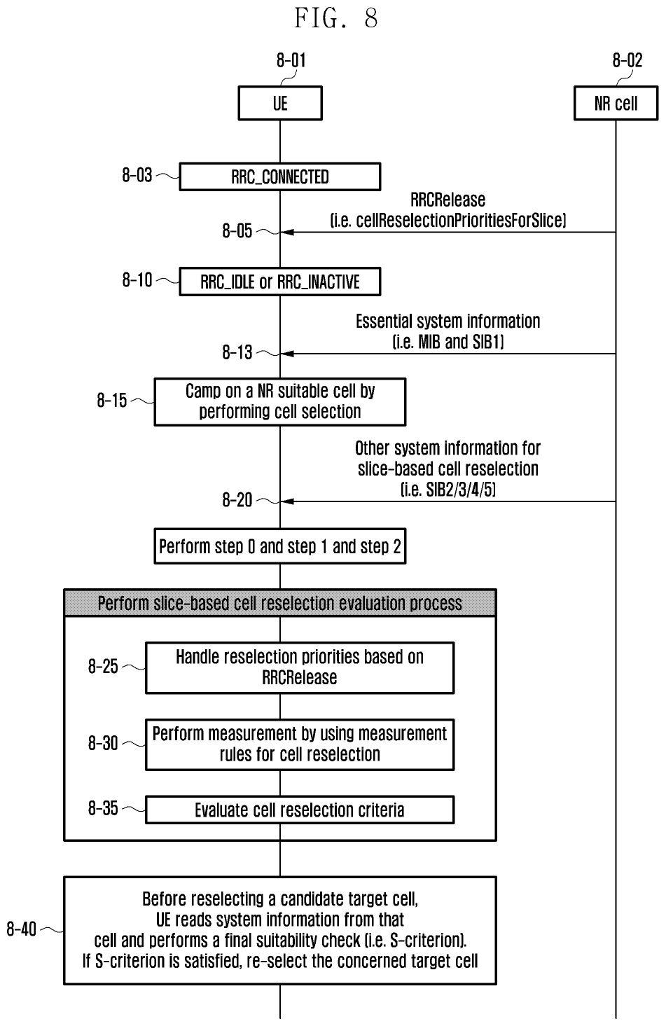

FIG. 8 illustrates that a terminal in an RRC idle mode (RRC_IDLE) or an RRC inactive state (RRC_INACTIVE) in a next-generation mobile communication system applies slice-based cell reselection priority (slice-based reselection priorities) information provided by an RRC release message to perform a slice-based cell reselection evaluation procedure according to an embodiment of the disclosure.

The slice-based cell reselection evaluation procedure may largely mean the following series of processes.
Step 0: NAS layer at UE provides slice information to AS layer at UE, including slice priority(ies) per each slice or each slice group.
Step 1: AS sorts slice(s) or slice group(s) in priority order starting with highest priority slice(s) or slice group(s).
Step 2: Select slice(s) or slice group(s) in priority order starting with the highest priority slice(s) or slice group(s).
Step 3: For the selected slice(s) or slice group(s) assign priority to frequencies received from network.
Step 4: Perform modified measurements or starting from the highest priority frequency(ies), perform modified measurement
Step 5: If the highest ranked cell is determined according to cell reselection criteria (for example, FIG. 6) and suitable and supports the selected slice in step 2 then camp on the cell and exit this sequence of operation;
Step 6: If there are remaining frequencies then go back to step 4.
Step 7: If the end of the slice list has not been reached go back to step 2.

Note that UE may not need to perform step 6 and/or step 7. In addition, step 1 and step 2 can be simplified as “select the highest priority slice(s) or slice group(s).”

Referring to FIG. 8, a terminal 8-01 may be in an RRC connected mode (RRC_CONNECTED) (operation 8-03).

In operation 8-05, an NR cell 8-02 may transmit an RRC Release message to the terminal 8-01 in the RRC connected mode. An embodiment of the disclosure proposes that cellReselectionPrioritiesForSlice is included in the RRC message. In the embodiment of the disclosure, when the NR cell 8-02 transmits the RRC release message to the terminal 8-01, the message includes only one of the above-described cellReselectionPriorities and cellReselectionPrioritiesForSlice. The cellReselectionPrioritiesForSlice may include at least one of the following information.

One or multiple slices (indicators) or slice groups (indicators)

One or multiple NR frequencies supported by each slice (indicator) or slice group (indicator)

Slice-based cell reselection priority configuration information for each NR frequency (cellReselectionPriorityForSlice and/or cellReselectionSubPriorityForSlice)

A list of neighboring cells supporting the slice (indicator) or the slice group (indicator) supported for each NR frequency. When the list of neighboring cells exists, the terminal 8-01 may perform a slice-based cell reselection evaluation procedure based on only a corresponding neighboring cell list. When the list of neighboring cells does not exist, the terminal 8-01 determines that all neighboring cells support the slice (indicator) or the slice group (indicator) at a corresponding NR frequency. Therefore, the terminal 8-01 may perform the slice-based cell reselection evaluation procedure in a list of all neighboring cells operating at the NR frequency.

A list of neighboring cells which do not support the slice (indicator) or the slice group (indicator) supported for each NR frequency. When the list of neighboring cells exists, the terminal 8-01 may perform a slice-based cell reselection evaluation procedure in the remaining neighboring cells other than a corresponding neighboring cell list at a corresponding NR frequency.

### New Timer Value

If cellReselectionPrioritiesForSlice is included in the RRC release message received by the terminal 8-01, the terminal 8-01 may store information included in the cellReselectionPrioritiesForSlice. If the RRC release message includes a new timer value, the terminal 8-01 may drive a new timer, based on the new timer value. In addition, while the new timer is running, a slice-based cell reselection process may be performed based on slice-based cell reselection priority configuration information included in the cellReselectionPrioritiesForSlice. For example, cell reselection priority configuration information and slice-based cell reselection priority configuration information broadcasted via system information may be ignored. If the RRC release message does not include the new timer value, the slice-based cell reselection process may be performed based on the slice-based cell reselection priority configuration information included in the cellReselectionPrioritiesForSlice when the cellReselectionPrioritiesForSlice is not deleted. If the driven new timer expires or the terminal 8-01 deletes the stored cellReselectionPrioritiesForSlice, the terminal 8-01 may perform a cell reselection procedure according to the above-described embodiment (FIG. 7 or FIG. 5).

In operation 8-10, when the RRC release message received in operation 8-05 includes suspension configuration information (suspendConfig), the terminal 8-01 may transition to an RRC inactive mode. In operation 8-10, when the RRC release message received in operation 8-05 does not include the suspension configuration information, the terminal 8-01 may transition to an RRC idle mode.

In operation 8-13, the terminal 8-01 in the RRC idle mode or the RRC inactive state may acquire essential system information from the NR cell 8-02. In an embodiment of the disclosure, a master information block (MIB) and system information block 1 (SIB1) may be referred to as essential system information.

In operation 8-15, the terminal 8-01 in the RRC idle mode or the RRC inactive state may perform a cell selection procedure, based on the essential system information acquired in operation 8-13. For example, the terminal 8-01 may find an NR suitable cell belonging to a selected PLMN or SNPN and camp on the corresponding cell. The definition of a suitable cell may refer to the above-described embodiment. The cell on which the terminal 8-01 has camped may be referred to as a serving cell.

In operation 8-20, the terminal 8-01 in the RRC idle mode or the RRC inactive state may acquire system information (for example, SIB2, SIB3, SIB4, and SIB5) including cell reselection information and/or slice-based cell reselection information from the serving cell 8-02 in order to perform a slice-based cell reselection evaluation procedure. The description of the system information acquired by the terminal 8-01 may refer to the above-described embodiment.

In operation 8-21, the terminal 8-01 in the RRC idle mode or the RRC inactive state supporting the slice-based cell reselection evaluation procedure may perform the following process.
Step 0: NAS layer at UE provides slice information to AS layer at UE, including slice priority(ies) per each slice or each slice group.
Step 1: AS sorts slice(s) or slice group(s) in priority order starting with highest priority slice(s) or slice group(s).
Step 2: Select slice(s) or slice group(s) in priority order starting with the highest priority slice(s) or slice group(s).

For reference, the terminal 8-01 may perform select the highest priority slice(s) or slice group(s) without performing Step 1 and Step 2. Alternatively, the terminal 8-01 may perform Step 1 and Step 2 before operation 8-21.

The terminal 8-01 in the RRC idle mode or the RRC inactive state may perform a slice-based cell reselection evaluation procedure (slice-based cell reselection evaluation process). The slice-based cell reselection evaluation procedure may refer to a series of processes of determining a slice-based reselection priority, applying measurement rules for slice-based cell reselection to perform frequency measurement, and evaluating the cell reselection criteria of the above-described embodiment to reselect a cell supporting the slice or the slice group selected in operation 8-21.

In operation 8-25, the terminal 8-01 in the RRC idle mode or the RRC inactive state may determine a slice-based reselection priority, based on the RRC release message received in operation 8-05. The terminal 8-01 may determine a slice-based reselection priority only for a frequency for which a slice-based cell reselection priority value is configured in the RRC release message, or support the slice or the slice group selected in operation 8-21 and determine the slice-based reselection priority only for the frequency for which the slice-based cell reselection priority value is configured. When the terminal 8-01 has camped on a suitable cell (that is, when the terminal is in a camped normally state), and when a slice-based reselection priority value exists only for the remaining frequencies other than the current serving frequency, a slice-based reselection priority value of the current serving frequency may be configured to be lower than slice-based reselection priority values configured in the RRC release message by a base station. For example, the current frequency may be determined as the lowest slice-based reselection priority. Alternatively, the terminal 8-01 may determine the slice-based reselection priority according to the above-described embodiment (FIG. 7).

In operation 8-30, the terminal 8-01 in the RRC idle mode or the RRC inactive state supporting the slice-based cell reselection evaluation procedure may perform frequency measurement to reselect a cell supporting the slice or the slice group selected by the terminal 8-01. An embodiment of the disclosure proposes that the terminal 8-01 performs frequency measurement by using the following measurement rule. For reference, the terminal 8-01 has a feature which can perform measurement on only a frequency supporting the slice or the slice group selected by the terminal 8-01. An inter-RAT frequency may be measured according to the above-described embodiment (FIG. 5).
If the slice or the slice group selected by the terminal 8-01 is not supported at an NR serving frequency or if a slice reselection priority is not applied to the NR serving frequency, NR intra-frequency measurement is not performed, NR Intra-frequency measurement is not performed.
If the slice or the slice group selected by the terminal 8-01 is supported at the NR serving frequency or if the terminal 8-01 applies the slice reselection priority to the NR serving frequency at the NR serving frequency, the terminal 8-01 may not perform NR intra-frequency measurement when the following condition 1 is satisfied. Otherwise (for example, when the following condition 1 is not satisfied), the terminal 8-01 performs NR intra-frequency measurement.
Condition 1: A reception level (Srxlev) of a serving cell is greater than an SIntraSearchP threshold value and a reception quality (Squal) of the serving cell is greater than an SIntraSearchQ threshold value (Serving cell fulfils Srxlev>SIntraSearchP and Squal>SIntraSearchQ).
If an indicator to measure an NR serving frequency which does not support the slice or the slice group selected by the terminal 8-01 is broadcasted to system information, the terminal 8-01 may measure the NR serving frequency according to the above-described embodiment.

For an NR inter-frequency or inter-RAT frequency having a slice reselection priority higher than an NR frequency of the current serving cell 8-02, the terminal 8-01 may perform measurement according to the 3GPP TS 38.133 standard.

For an NR inter-frequency having a slice reselection priority lower than or equal to the NR frequency of the current serving cell 8-02, the terminal 8-01 may not perform measurement when the following condition 2 is satisfied. Otherwise, (for example, when the following condition 2 is not satisfied), the terminal 8-01 measures cells in the NR inter-frequency having the slice reselection priority lower than or equal to the NR frequency.
Condition 2: A reception level (Srxlev) of a serving cell is greater than an SnonIntraSearchP threshold value and a reception quality (Squal) of the serving cell is greater than an SnonIntraSearchQ threshold value (Serving cell fulfils Srxlev>SnonIntraSearchP and Squal>SnonIntraSearchQ).

For reference, the above-described threshold values (SintraSearchP, SintraSearchQ, SnonIntraSearchP SnonintraSearchQ) may be broadcasted via the system information acquired in operation 8-20.

In operation 8-35, the terminal 8-01 in the RRC idle mode or the RRC inactive state may determine to reselect a cell satisfying cell reselection criteria, based on a value of the measurement performed in operation 8-30. The above-described embodiment may be followed based on the slice reselection priority. When, in operation 8-35, the highest ranked cell is not suitable and/or the slice or the slice group selected in operation 8-21 is not supported, and when the terminal 8-01 has determined the slice reselection priority in operation 8-25 but a frequency which has not been measured exists, the terminal 8-01 may perform again from operation 8-30. Alternatively, the terminal 8-01 may perform again from operation 8-25 for a slice or a slice group having the second highest priority in operation 8-21. If the highest ranked cell is not suitable and/or the terminal 8-01 in the RRC idle mode or the RRC inactive state cannot reselect a cell supporting the slice or the slice group selected in operation 8-21, while a new timer is running or when cellReselectionPrioritiesForSlice is stored in the terminal 8-01, the terminal 8-01 cannot reselect the cell according to the above-described embodiment (FIG. 5 or FIG. 7). For example, only when the new timer expires or the cellReselectionPrioritiesForSlice is deleted, the terminal 8-01 may reselect the cell according to the above-described embodiment (FIG. 5 or FIG. 7).

In operation 8-40, the terminal 8-01 in the RRC idle mode or the RRC inactive state receives system information (for example, MIB or SIB1) broadcasted from a corresponding cell before finally reselecting a candidate target cell, and determines whether a reception level (Srxlev) and a reception quality (Squal) of the target cell fulfill a cell selection criterion called S-criterion (Equation 1) (Srxlev>0 AND Squal>0), based on the received system information. When Equation 1 is satisfied, the candidate target cell is suitable, and the candidate target cell supports the slice or the slice group selected by the terminal 8-01, the terminal 8-01 may reselect the corresponding cell.

The characteristics of the NR cell and the terminal according to an embodiment of the disclosure may be defined as follows.

1. If the terminal in the RRC idle mode or the RRC inactive state supporting the slice-based cell reselection evaluation procedure has performed the slice-based cell reselection procedure, based on the RRC release message, but fails to reselect a cell, the terminal cannot perform the cell reselection procedure, based on the system information, without considering a slice according to the above-described embodiment. For example, only when the new timer expires or the cellReselectionPrioritiesForSlice is deleted, the terminal may reselect the cell according to the above-described embodiment (FIG. 5 or FIG. 7).

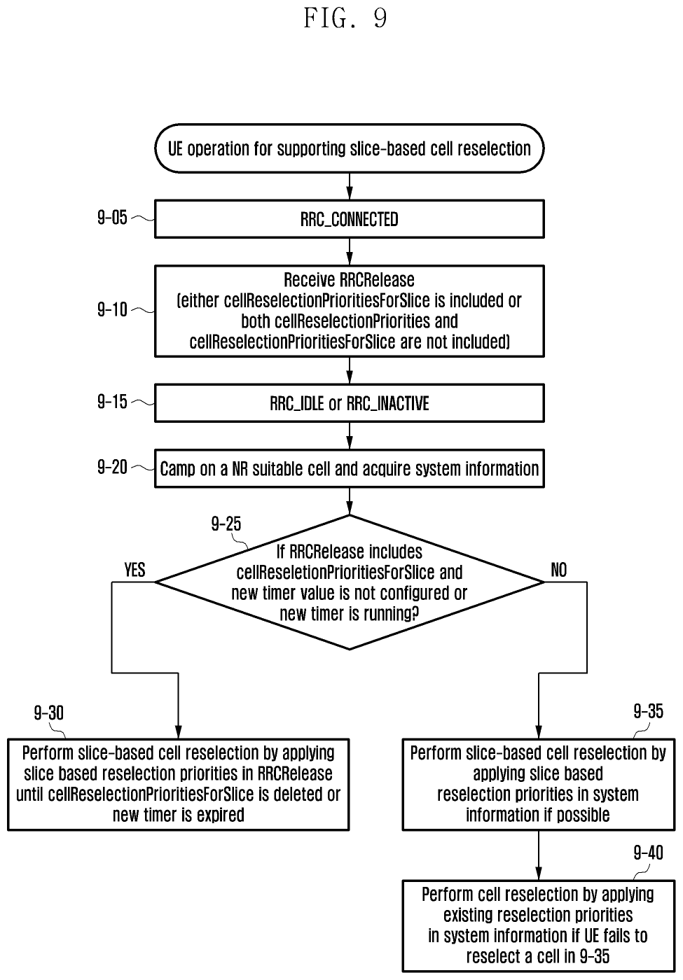

FIG. 9 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure.

Referring to FIG. 9, a terminal supporting a slice-based cell reselection evaluation procedure may be in an RRC connected mode (RRC_CONNECTED) by establishing an RRC connection with an NR cell (operation 9-05).

In operation 9-10, the terminal may receive an RRC release message. The message may include cellReselectionPrioritiesForSlice or may not include both cellReselectionPriorities and cellReselectionPrioritiesForSlice. If the message includes the cellReselectionPrioritiesForSlice, the terminal may store the received cellReselectionPrioritiesForSlice. Additionally, when a new timer value is included in the cellReselectionPrioritiesForSlice, the terminal may drive a new timer with the new timer value.

In operation 9-15, the terminal may apply the received RRC release message and transition to an RRC idle mode (RRC_IDLE) or an RRC inactive state (RRC_INACTIVE).

In operation 9-20, the terminal may camp on an NR suitable cell and acquire system information from the corresponding cell.

In operation 9-25, when the RRC release message received in operation 9-10 includes the cellReselectionPrioritiesForSlice but does not include the new timer value, or when the received RRC release message includes the cellReselectionPrioritiesForSlice and includes the new timer value, the terminal may determine whether the new timer is continuously running

When, in operation 9-25, the terminal stores the cellReselectionPrioritiesForSlice received via the RRC release message in operation 9-05 and does not drive the new timer or the terminal stores the cellReselectionPrioritiesForSlice received via the RRC release message in operation 9-05 and determines that the new timer is running, the terminal may perform a slice-based cell reselection procedure by applying the cellReselectionPrioritiesForSlice in operation 9-30. For reference, when the stored cellReselectionPrioritiesForSlice is released or the new timer expires, the terminal may perform operation 9-35. In an embodiment of the disclosure, the terminal performing operation 9-30 cannot perform a cell reselection procedure which does not consider a slice.

When, in operation 9-25, the RRC release message received in operation 9-10 does not include the cellReselectionPrioritiesForSlice or the driven new timer expires, the terminal may perform the slice-based cell reselection procedure by applying a slice-based cell reselection priority, based on the system information in operation 9-35. For reference, in order to perform the slice-based cell reselection procedure, a slice-based cell reselection priority value is required to be included in the system information.

In operation 9-40, when the terminal performs operation 9-35 and fails to reselect a cell supporting a slice or a slice group selected by the terminal according to the above-described embodiments of the disclosure, the terminal may perform a cell reselection procedure, based on a reselection priority broadcasted via the system information without considering a slice according to the above-described embodiment. In an embodiment of the disclosure, when the terminal performing the slice-based cell reselection procedure according to the slice-based cell reselection priority broadcasted via the system information fails to reselect the cell supporting the slice or the slice group selected by the terminal according to the above-described embodiments of the disclosure, the terminal may additionally perform the cell reselection procedure, based on the reselection priority broadcasted via the system information without considering the slice.

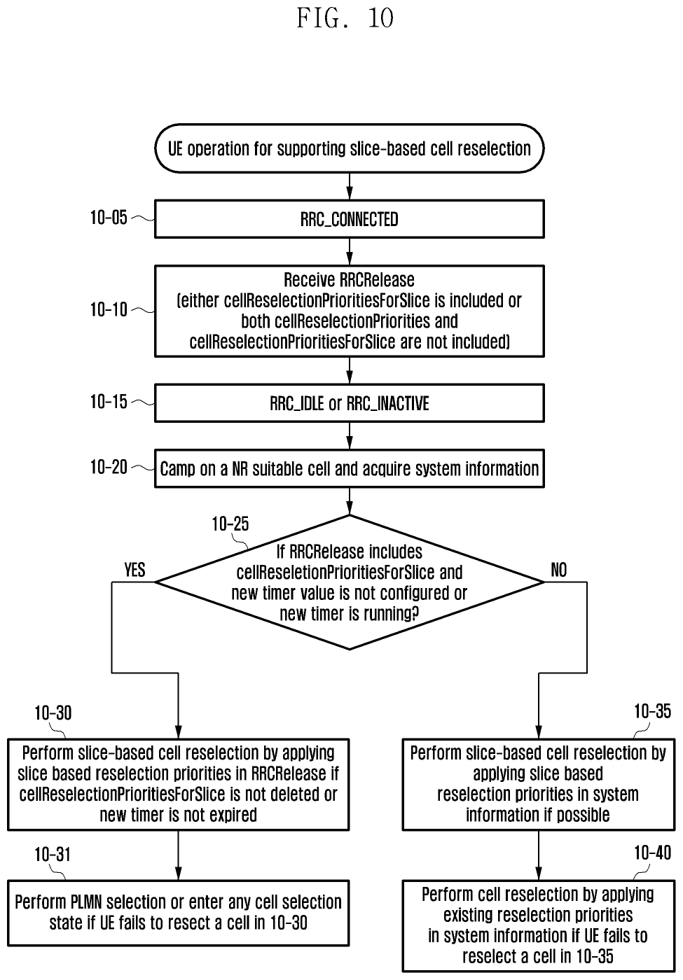

FIG. 10 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure.

Referring to FIG. 10, a terminal supporting a slice-based cell reselection evaluation procedure may be in an RRC connected mode (RRC_CONNECTED) by establishing an RRC connection with an NR cell (operation 10-05).

In operation 10-10, the terminal may receive an RRC release message. The message may include cellReselectionPrioritiesForSlice or may not include both cellReselectionPriorities and cellReselectionPrioritiesForSlice. If the message includes the cellReselectionPrioritiesForSlice, the terminal may store the received cellReselectionPrioritiesForSlice. Additionally, when a new timer value is included in the cellReselectionPrioritiesForSlice, the terminal may drive a new timer with the new timer value.

In operation 10-15, the terminal may apply the received RRC release message and transition to an RRC idle mode (RRC_IDLE) or an RRC inactive state (RRC_INACTIVE).

In operation 10-20, the terminal may camp on an NR suitable cell and acquire system information from the corresponding cell.

In operation 10-25, when the RRC release message received in operation 10-10 includes the cellReselectionPrioritiesForSlice but does not include the new timer value, or when the received RRC release message includes the cellReselectionPrioritiesForSlice and includes the new timer value, the terminal may determine whether the new timer is continuously running

When, in operation 10-25, the terminal stores the cellReselectionPrioritiesForSlice received via the RRC release message in operation 10-05 and does not drive the new timer or the terminal stores the cellReselectionPrioritiesForSlice received via the RRC release message in operation 10-05 and determines that the new timer is running, the terminal may perform a slice-based cell reselection procedure by applying the cellReselectionPrioritiesForSlice in operation 10-30. For reference, when the stored cellReselectionPrioritiesForSlice is released or the new timer expires, the terminal may perform operation 10-35.

When, in operation 10-30, the terminal performs the slice-based cell reselection procedure and fails to reselect a cell, in operation 10-31, the terminal may select a PLMN or directly transition to any cell selection state. For reference, when the terminal performs the slice-based cell reselection procedure and fails to reselect a cell, the above-described embodiment may be followed. If the PLMN is selected, the cellReselectionPrioritiesForSlice received by the RRC release message may be released and a cell selection process may be performed. When the terminal transitions to any cell selection state, the terminal may maintain or release the stored cellReselectionPrioritiesForSlice via the RRC release message.

When, in operation 10-25, the RRC release message received in operation 10-10 does not include the cellReselectionPrioritiesForSlice or the driven new timer expires, the terminal may perform the slice-based cell reselection procedure by applying a slice-based cell reselection priority, based on the system information in operation 10-35. For reference, in order to perform the slice-based cell reselection procedure, a slice-based cell reselection priority value is required to be included in the system information.

In operation 10-40, when the terminal performs operation 10-35 and fails to reselect a cell supporting a slice or a slice group selected by the terminal according to the above-described embodiments of the disclosure, the terminal may perform a cell reselection procedure, based on a reselection priority broadcasted via the system information without considering a slice according to the above-described embodiment. In an embodiment of the disclosure, when the terminal performing the slice-based cell reselection procedure according to the slice-based cell reselection priority broadcasted via the system information fails to reselect the cell supporting the slice or the slice group selected by the terminal according to the above-described embodiments of the disclosure, the terminal may additionally perform the cell reselection procedure, based on the reselection priority broadcasted via the system information without considering the slice.

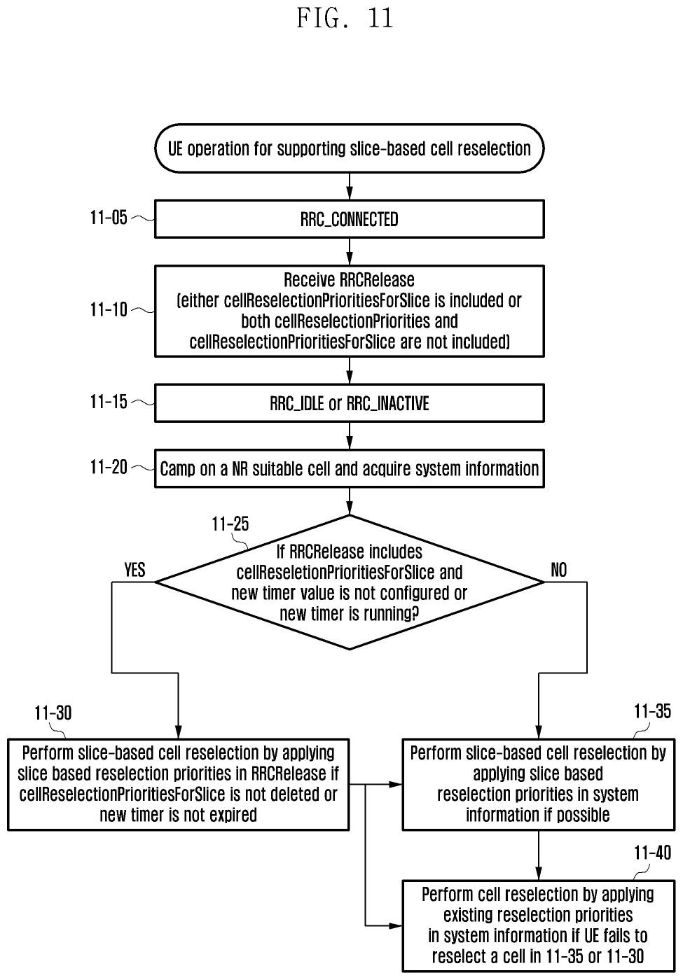

FIG. 11 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure.

Referring to FIG. 11, a terminal supporting a slice-based cell reselection evaluation procedure may be in an RRC connected mode (RRC_CONNECTED) by establishing an RRC connection with an NR cell (operation 11-05).

In operation 11-10, the terminal may receive an RRC release message. The message may include cellReselectionPrioritiesForSlice or may not include both cellReselectionPriorities and cellReselectionPrioritiesForSlice. If the message includes the cellReselectionPrioritiesForSlice, the terminal may store the received cellReselectionPrioritiesForSlice. Additionally, when a new timer value is included in the cellReselectionPrioritiesForSlice, the terminal may drive a new timer with the new timer value.

In operation 11-15, the terminal may apply the received RRC release message and transition to an RRC idle mode (RRC_IDLE) or an RRC inactive state (RRC_INACTIVE).

In operation 11-20, the terminal may camp on an NR suitable cell and acquire system information from the corresponding cell.

In operation 11-25, when the RRC release message received in operation 11-10 includes the cellReselectionPrioritiesForSlice but does not include the new timer value, or when the received RRC release message includes the cellReselectionPrioritiesForSlice and includes the new timer value, the terminal may determine whether the new timer is continuously running

When, in operation 11-25, the terminal stores the cellReselectionPrioritiesForSlice received via the RRC release message in operation 11-05 and does not drive the new timer or the terminal stores the cellReselectionPrioritiesForSlice received via the RRC release message in operation 11-05 and determines that the new timer is running, the terminal may perform a slice-based cell reselection procedure by applying the cellReselectionPrioritiesForSlice in operation 11-30. For reference, when the stored cellReselectionPrioritiesForSlice is released or the new timer expires, the terminal may perform operation 11-35.

When, in operation 11-30, the terminal performs the slice-based cell reselection procedure and fails to reselect a cell, the terminal may perform operation 11-35 or directly perform operation 11-40. For example, when the terminal fails to reselect a cell supporting a slice selected by the terminal by applying a cell reselection priority for slice, based on the RRC release message (according to the above-described embodiment), the terminal may reselect the cell supporting the slice selected by the terminal by applying the cell reselection priority for slice, based on the system information, or reselect the cell by performing a cell reselection procedure which does not consider a slice, based on the system information. In this case, the terminal continues to maintain the cellReselectionPrioritiesForSlice received via the RRC release message, and if the new timer is running, the terminal may continue to drive the new timer. This is to enable the terminal to continue performing the slice-based cell reselection evaluation procedure by applying the cell reselection priority for slice, based on the RRC release message, after the reselection of the cell. Alternatively, when the terminal performs operation 11-35 or performs operation 11-40 to reselect a cell, the terminal releases the cellReselectionPrioritiesForSlice received via the RRC release message, and if the new timer is running, the terminal may stop the running new timer.

When, in operation 11-25, the RRC release message received in operation 11-10 does not include the cellReselectionPrioritiesForSlice or the driven new timer expires, the terminal may perform the slice-based cell reselection procedure by applying a slice-based cell reselection priority, based on the system information in operation 11-35. For reference, in order to perform the slice-based cell reselection procedure, a slice-based cell reselection priority value is required to be included in the system information.

In operation 11-40, when the terminal performs operation 11-35 and fails to reselect a cell supporting a slice or a slice group selected by the terminal according to the above-described embodiments of the disclosure, the terminal may perform a cell reselection procedure, based on a reselection priority broadcasted via the system information without considering a slice according to the above-described embodiment. In an embodiment of the disclosure, when the terminal performing the slice-based cell reselection procedure according to the slice-based cell reselection priority broadcasted via the system information fails to reselect the cell supporting the slice or the slice group selected by the terminal according to the above-described embodiments of the disclosure, the terminal may additionally perform the cell reselection procedure, based on the reselection priority broadcasted via the system information without considering the slice.

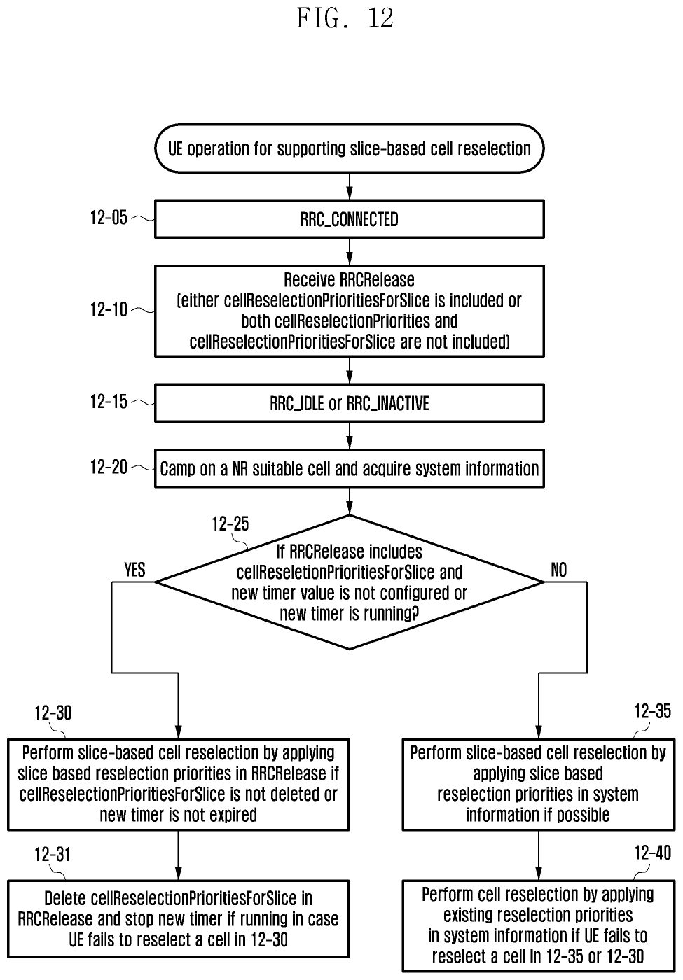

FIG. 12 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure.

Referring to FIG. 12, a terminal supporting a slice-based cell reselection evaluation procedure may be in an RRC connected mode (RRC_CONNECTED) by establishing an RRC connection with an NR cell (operation 12-05).

In operation 12-10, the terminal may receive an RRC release message. The message may include cellReselectionPrioritiesForSlice or may not include both cellReselectionPriorities and cellReselectionPrioritiesForSlice. If the message includes the cellReselectionPrioritiesForSlice, the terminal may store the received cellReselectionPrioritiesForSlice. Additionally, when a new timer value is included in the cellReselectionPrioritiesForSlice, the terminal may drive a new timer with the new timer value.

In operation 12-15, the terminal may apply the received RRC release message and transition to an RRC idle mode (RRC_IDLE) or an RRC inactive state (RRC_INACTIVE).

In operation 12-20, the terminal may camp on an NR suitable cell and acquire system information from the corresponding cell.

In operation 12-25, when the RRC release message received in operation 12-10 includes the cellReselectionPrioritiesForSlice but does not include the new timer value, or when the received RRC release message includes the cellReselectionPrioritiesForSlice and includes the new timer value, the terminal may determine whether the new timer is continuously running

When, in operation 12-25, the terminal stores the cellReselectionPrioritiesForSlice received via the RRC release message in operation 12-05 and does not drive the new timer or the terminal stores the cellReselectionPrioritiesForSlice received via the RRC release message in operation 12-05 and determines that the new timer is running, the terminal may perform a slice-based cell reselection procedure by applying the cellReselectionPrioritiesForSlice in operation 12-30. For reference, when the stored cellReselectionPrioritiesForSlice is released or the new timer expires, the terminal may perform operation 12-35.

When, in operation 12-30, the terminal performs the slice-based cell reselection procedure and fails to reselect a cell, the terminal may release the cellReselectionPrioritiesForSlice received via the RRC release message, and if the new timer is running, the terminal may stop the new timer in operation 12-31. For reference, when the terminal fails to reselect a cell supporting a slice selected by the terminal by applying a cell reselection priority for slice, based on the RRC release message, the above-described embodiment may be followed. The terminal releases the cellReselectionPrioritiesForSlice received via the RRC release message and stops the new timer if the new timer is running, so that the terminal may perform operation 12-35, directly perform operation 12-40, select a PLMN, or perform a cell selection procedure.

When, in operation 12-25, the RRC release message received in operation 12-10 does not include the cellReselectionPrioritiesForSlice or the driven new timer expires, the terminal may perform the slice-based cell reselection procedure by applying a slice-based cell reselection priority, based on the system information in operation 12-35. For reference, in order to perform the slice-based cell reselection procedure, a slice-based cell reselection priority value is required to be included in the system information.

In operation 12-40, when the terminal performs operation 12-35 and fails to reselect a cell supporting a slice or a slice group selected by the terminal according to the above-described embodiments of the disclosure, the terminal may perform a cell reselection procedure, based on a reselection priority broadcasted via the system information without considering a slice according to the above-described embodiment. In an embodiment of the disclosure, when the terminal performing the slice-based cell reselection procedure according to the slice-based cell reselection priority broadcasted via the system information fails to reselect the cell supporting the slice or the slice group selected by the terminal according to the above-described embodiments of the disclosure, the terminal may additionally perform the cell reselection procedure, based on the reselection priority broadcasted via the system information without considering the slice.

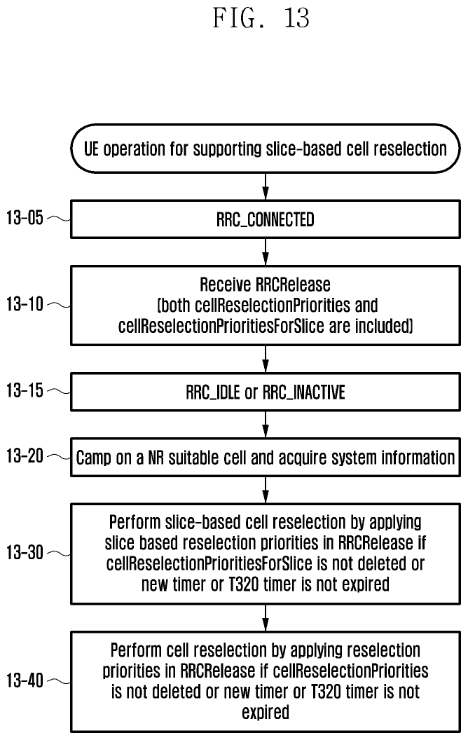

FIG. 13 is a flowchart illustrating an operation of a terminal which is in an RRC idle mode (RRC_IDLE) or an RRC inactive state (RRC_INACTIVE) and falls back to a cell reselection evaluation procedure without consideration of a slice in a slice-based cell reselection evaluation procedure by applying slice-based cell reselection priority (slice-based reselection priorities) information in a next-generation mobile communication system according to an embodiment of the disclosure.

Referring to FIG. 13, a terminal supporting a slice-based cell reselection evaluation procedure may be in an RRC connected mode (RRC_CONNECTED) by establishing an RRC connection with an NR cell (operation 13-05).

In operation 13-10, the terminal may receive an RRC release message. The message may include both cellReselectionPriorities and cellReselectionPrioritiesForSlice. The terminal may store the received cellReselectionPriorities and cellReselectionPrioritiesForSlice. Additionally, the message may separately include a new or T320 timer value of the related art commonly applied to the cellReselectionPriorities and the cellReselectionPrioritiesForSlice, or a T320 timer value of the related art applied to the cellReselectionPriorities and a new timer value applied to the cellReselectionPrioritiesForSlice. If the message includes the new or T320 timer value of the related art commonly applied to the cellReselectionPriorities and the cellReselectionPrioritiesForSlice, the terminal may drive a T320 or new timer by applying the received new or T320 timer value of the related art. If the message separately includes the T320 timer value of the related art applied to the cellReselectionPriorities and the new timer value applied to the cellReselectionPrioritiesForSlice, the terminal may drive the T320 timer and the new timer by applying each of the received timer values. For reference, the T320 timer may be driven in operation 13-31.

In operation 13-15, the terminal may apply the received RRC release message and transition to an RRC idle mode (RRC_IDLE) or an RRC inactive state (RRC_INACTIVE).

In operation 13-20, the terminal may camp on an NR suitable cell and acquire system information from the corresponding cell.

In operation 13-30, if at least one of the following conditions is satisfied, the terminal may perform a slice-based cell reselection procedure, based on the cellReselectionPrioritiesForSlice received via the RRC release message in operation 13-05.

Condition 1: When the RRC connection message received in operation 13-10 does not include a new or T320 timer value of the related art commonly applied to the cellReselectionPriorities and the cellReselectionPrioritiesForSlice, or a new or T320 timer of the related art is driven

Condition 2: When the RRC connection message received in operation 13-05 does not include a new timer value independently applied to the cellReselectionPrioritiesForSlice or a new timer is driven

When, in operation 13-30, the terminal performs the slice-based cell reselection procedure and fails to reselect a cell (according to the above-described embodiment), the terminal may perform a cell reselection procedure which does not consider a slice, based on the cellReselectionPriorities received via the RRC release message. For reference, at least one of the following conditions may be required to be satisfied in order to perform the cell reselection procedure which does not consider a slice, based on the cellReselectionPriorities received via the RRC release message.

Condition 3: When the RRC connection message received in operation 13-05 does not include a new or T320 timer value of the related art commonly applied to the cellReselectionPriorities and the cellReselectionPrioritiesForSlice, or a new or T320 timer of the related art is driven

Condition 4: When the RRC connection message received in operation 13-05 does not include a new timer value independently applied to the cellReselectionPriorities or a new timer is driven

In operation 13-40, the terminal may release the cellReselectionPrioritiesForSlice received via the RRC release message (at the time of cell reselection or at operation 13-40) or the terminal may stop the running new timer when the timer is independently applied to the cellReselectionPriorities and the cellReselectionPrioritiesForSlice.

In the embodiment of the disclosure, the RRC release message includes both the cellReselectionPriorities and cellReselectionPrioritiesForSlice.

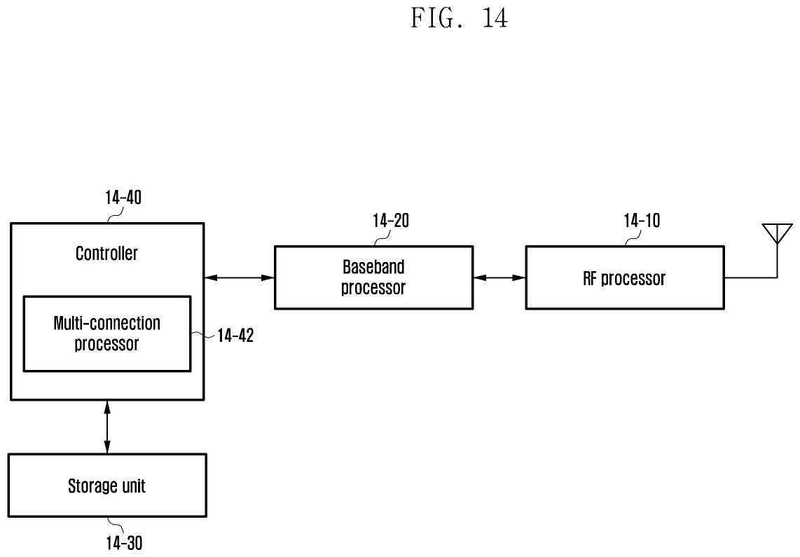

FIG. 14 is a block diagram illustrating a configuration of a terminal according to an embodiment of the disclosure.

Referring to FIG. 14, the terminal includes a radio frequency (RF) processor 14-10, a baseband processor 14-20, a storage unit 14-30, and a controller 14-40. The controller 14-40 may further include a multi-connection processor 14-42.

The RF processor 14-10 performs functions of transmitting or receiving a signal via a wireless channel, such as band conversion and amplification of the signal. For example, the RF processor 14-10 up-converts a baseband signal provided from the baseband processor 14-20 into an RF band signal and then transmits the RF band signal via an antenna, and down-converts the RF band signal received via the antenna into the baseband signal. For example, the RF processor 14-10 may include a transmission filter, a reception filter, an amplifier, a mixer, an oscillator, a digital to analog convertor (DAC), an analog to digital convertor (ADC), and the like. In the drawing, only one antenna is shown, but the terminal may include a plurality of antennas. In addition, the RF processor 14-10 may include a plurality of RF chains. Furthermore, the RF processor 14-10 may perform beamforming. For the beamforming, the RF processor 14-10 may adjust a phase and a size of each of signals transmitted or received via the plurality of antennas or antenna elements. In addition, the RF processor may perform MIMO, and may receive multiple layers when performing a MIMO operation.

The baseband processor 14-20 performs a conversion function between a baseband signal and a bit stream according to a physical layer specification of a system. For example, at the time of data transmission, the baseband processor 14-20 generates complex symbols by encoding and modulating transmission bit streams. In addition, at the time of data reception, the baseband processor 14-20 may demodulate and decode a baseband signal provided from the RF processor 14-10 to restore a reception bit stream. For example, when data is transmitted according to an orthogonal frequency division multiplexing (OFDM) scheme, the baseband processor 14-20 generates complex symbols by encoding and modulating transmission bit streams and maps the complex symbols to sub-carriers, and then configures OFDM symbols via an inverse fast Fourier transform (IFFT) operation and a cyclic prefix (CP) insertion. In addition, at the time of data reception, the baseband processor 14-20 divides a baseband signal provided from the RF processor 14-10 into the units of OFDM symbols and recovers the signals mapped to the sub-carriers via a fast Fourier transform (FFT) operation, and then restores a reception bit stream via demodulation and decoding.

The baseband processor 14-20 and the RF processor 14-10 transmits and receives a signal as described above. Accordingly, the baseband processor 14-20 and the RF processor 14-10 may be referred to as a transmitter, a receiver, a transceiver, or a communicator. Furthermore, at least one of the baseband processor 14-20 and the RF processor 14-10 may include a plurality of communication modules in order to support different radio access technologies. In addition, at least one of the baseband processor 14-20 and the RF processor 14-10 may include different communication modules in order to process signals of different frequency bands. For example, the different radio access technologies may include a wireless LAN (e.g., institute of electrical and electronics engineers (IEEE) 802.11), a cellular network (e.g., LTE), and the like. In addition, the different frequency bands may include a super high frequency (SHF) (e.g., 2. NRHz, NRhz) band, and a millimeter wave (e.g., 60 GHz) band.

The storage unit 14-30 stores data, such as a basic program, an application program, and configuration information for the operation of the terminal. More particularly, the storage unit 14-30 may store information related to a second access node which performs wireless communication by using a second radio access technology. In addition, the storage unit 14-30 provides stored data according to a request of the controller 14-40.

The controller 14-40 controls the overall operations of the terminal. For example, the controller 14-40 transmits or receives a signal through the baseband processor 14-20 and the RF processor 14-10. In addition, the controller 14-40 records and reads data on and from the storage unit 14-30. To this end, the controller 14-40 may include at least one processor. For example, the controller 14-40 may include a communication processor (CP) which performs a control for communication, and an application processor (AP) which controls an upper layer, such as an application program. In addition, the controller 14-40 may control a cell reselection operation of the terminal according to various embodiments of the disclosure.

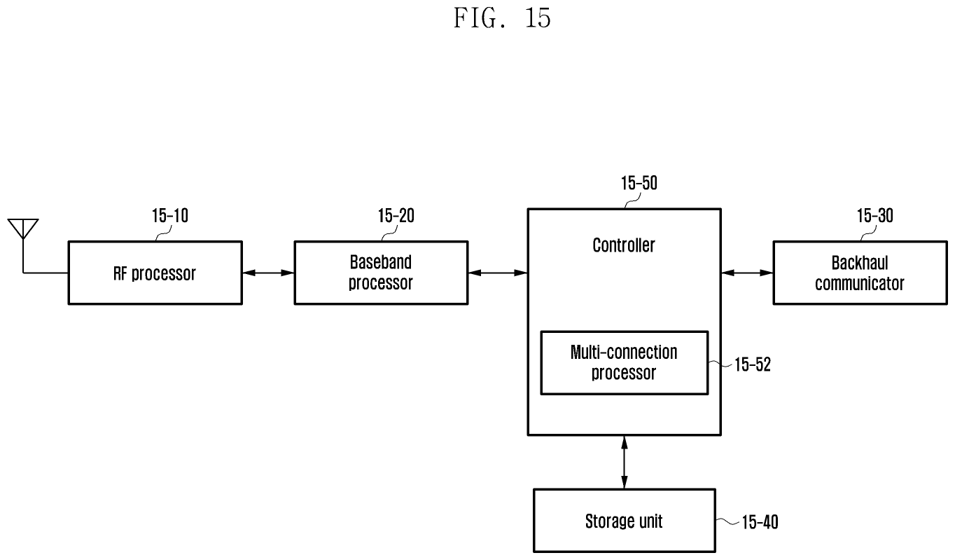

FIG. 15 is a block diagram illustrating a configuration of an NR base station according to an embodiment of the disclosure.

Referring to FIG. 15, the base station includes an RF processor 15-10, a baseband processor 15-20, a backhaul communicator 15-30, a storage unit 15-40, and a controller 15-50. The controller 15-50 may further include a multi-connection processor 15-52.

The RF processor 15-10 performs functions of transmitting or receiving a signal via a wireless channel, such as band conversion and amplification of the signal. For example, the RF processor 15-10 up-converts a baseband signal provided from the baseband processor 15-20 into an RF band signal and then transmits the RF band signal via an antenna, and down-converts the RF band signal received via the antenna into the baseband signal. For example, the RF processor 15-10 may include a transmission filter, a reception filter, an amplifier, a mixer, an oscillator, a DAC, an ADC, and the like. In the drawing, only one antenna is shown, but a first access node may include a plurality of antennas. In addition, the RF processor 15-10 may include a plurality of RF chains. Furthermore, the RF processor 15-10 may perform beamforming. For the beamforming, the RF processor 15-10 may adjust a phase and a size of each of signals transmitted or received via the plurality of antennas or antenna elements. The RF processor may perform a downlink MIMO operation by transmitting one or more layers.

The baseband processor 15-20 performs a conversion function between a baseband signal and a bit stream according to a physical layer standard of a first radio access technology. For example, at the time of data transmission, the baseband processor 15-20 generates complex symbols by encoding and modulating transmission bit streams. In addition, at the time of data reception, the baseband processor 15-20 demodulates and decodes a baseband signal provided from the RF processor 15-10 to restore a reception bit stream. For example, when data is transmitted according to an OFDM scheme, the baseband processor 15-20 generates complex symbols by encoding and modulating transmission bit streams and maps the complex symbols to sub-carriers, and then configures OFDM symbols via an IFFT operation and a CP insertion. In addition, at the time of data reception, the baseband processor 15-20 divides a baseband signal provided from the RF processor 15-10 into the units of OFDM symbols and recovers the signals mapped to the sub-carriers via an FFT operation, and then restores a reception bit stream via demodulation and decoding. The baseband processor 15-20 and the RF processor 15-10 transmits and receives a signal as described above. Accordingly, the baseband processor 15-20 and the RF processor 15-10 may be referred to as a transmitter, a receiver, a transceiver, a communicator, or a wireless communicator.

The backhaul communicator 15-30 provides an interface for performing communication with other nodes in the network. For example, the backhaul communicator 15-30 converts a bit stream transmitted from a main base station to another node, for example, an auxiliary base station, a core network, or the like, into a physical signal, and converts the physical signal received from the other node into a bit stream.

The storage unit 15-40 stores data, such as a basic program, an application program, and configuration information for the operation of the main base station. More particularly, the storage unit 15-40 may store information on a bearer assigned to an accessed terminal, a measurement result reported from the accessed terminal, and the like. In addition, the storage unit 15-40 may store information serving as a standard for determining whether to provide multiple connections to the terminal or stop the multiple connections. In addition, the storage unit 15-40 provides stored data according to a request of the controller 15-50.

The controller 15-50 controls the overall operations of the main base station. For example, the controller 15-50 transmits or receives a signal through the baseband processor 15-20 and the RF processor 15-10 or through the backhaul communicator 15-30. In addition, the controller 15-50 records and reads data on and from the storage unit 15-40. To this end, the controller 15-50 may include at least one processor. In addition, the controller 15-50 may control the operation of the base station according to various embodiments of the disclosure.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks, such as the Internet, Intranet, local area network (LAN), Wide LAN (WLAN), and storage area network (SAN) or a combination thereof. Such a storage device may access the electronic device via an external port. Further, a separate storage device on the communication network may access a portable electronic device.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving a radio resource control (RRC) release message including first information on cell reselection priority for slice;
storing the first information on cell reselection priority for slice;
starting a timer for cell reselection, in case that time value for the timer is included in the RRC release message; and
performing cell reselection based on the first information on cell reselection priority for slice, in case that the timer does not expire.

2. The method of claim 1, wherein the RRC release message further includes second information on cell reselection priority.

3. The method of claim 1, wherein the stored first information on cell reselection priority for slice is discarded in case that the timer expires.

4. The method of claim 2, wherein the first information on cell reselection priority for slice has a higher priority than the second information on cell reselection priority.

5. The method of claim 2, wherein the time value for the timer is applied both the first information on cell reselection priority for slice and the second information on cell reselection priority.

6. The method of claim 1, wherein the first information on cell reselection priority for slice includes an identity of a slice group, frequency information associated with the slice group, cell reselection priority of the slice group.

7. A method performed by a base station in a wireless communication system, the method comprising:
transmitting, to a terminal, a radio resource control (RRC) release message including first information on cell reselection priority for slice and second information on cell reselection priority; and
performing cell reselection with the terminal based on the first information on cell reselection priority for slice, in case that a timer does not expire,
wherein time value for the timer is included in the RRC release message, and
wherein the time value for the timer is applied both the first information on cell reselection priority for slice and the second information on cell reselection priority.

8. The method of claim 7, wherein the first information on cell reselection priority for slice is discarded in case that the timer expires.

9. The method of claim 7, wherein the first information on cell reselection priority for slice has a higher priority than the second information on cell reselection priority.

10. The method of claim 7, wherein the first information on cell reselection priority for slice includes an identity of a slice group, frequency information associated with the slice group, cell reselection priority of the slice group.

11. A terminal in a wireless communication system, the terminal comprising:
a transceiver; and
at least one processor configured to:
receive a radio resource control (RRC) release message including first information on cell reselection priority for slice,
store the first information on cell reselection priority for slice,
start a timer for cell reselection, in case that time value for the timer is included in the RRC release message, and
perform cell reselection based on the first information on cell reselection priority for slice, in case that the timer does not expire.

12. The terminal of claim 11, wherein the RRC release message further includes second information on cell reselection priority.

13. The terminal of claim 11, wherein the stored first information on cell reselection priority for slice is discarded in case that the timer expires.

14. The terminal of claim 12, wherein the first information on cell reselection priority for slice has a higher priority than the second information on cell reselection priority.

15. The terminal of claim 12, wherein the time value for the timer is applied both the first information on cell reselection priority for slice and the second information on cell reselection priority.

16. The terminal of claim 11, wherein the first information on cell reselection priority for slice includes an identity of a slice group, frequency information associated with the slice group, cell reselection priority of the slice group.

17. A base station in a wireless communication system, the base station comprising:
a transceiver; and
at least one processor configured to:
transmit, to a terminal, a radio resource control (RRC) release message including first information on cell reselection priority for slice and second information on cell reselection priority, and
perform cell reselection with the terminal based on the first information on cell reselection priority for slice, in case that a timer does not expire,
wherein time value for the timer is included in the RRC release message, and
wherein the time value for the timer is applied both the first information on cell reselection priority for slice and the second information on cell reselection priority.

18. The base station of claim 17, wherein the first information on cell reselection priority for slice is discarded in case that the timer expires.

19. The base station of claim 17, wherein the first information on cell reselection priority for slice has a higher priority than the second information on cell re selection priority.

20. The base station of claim 17, wherein the first information on cell reselection priority for slice includes an identity of a slice group, frequency information associated with the slice group, cell reselection priority of the slice group.
